(19) United States
(12) Patent Application Publication
(10) Pub. No.: US 2026/0310295 A1
(43) Pub. Date: Oct. 8, 2026

(54) Antenna Design for Ultra-Wideband Communication on an Implanted Device

(71) Applicant: Echo Neurotechnologies Corporation, San Francisco, CA (US)

(72) Inventors: Ahmad Reza Tavakoli Hosseinabadi, San Francisco, CA (US); Kyle William Gilpin, Bishop, CA (US)

(21) Appl. No.: 19/636,819

(22) Filed: Apr. 1, 2026

Related U.S. Application Data
(60) Provisional application No. 63/783,751, filed on Apr. 4, 2025.
(60) Provisional application No. 63/783,757, filed on Apr. 4, 2025.

(51) Int. Cl. G06F 3/01; H01Q 1/22; H01Q 1/52; H01Q 5/25; H02J 50/10

(52) U.S. Cl. CPC G06F 3/015; H01Q 1/2291; H01Q 1/526; H01Q 5/25; H02J 50/10

(57) ABSTRACT

Some embodiments are directed to brain computer interface (BCI) systems that include antennas for ultra-wideband (UWB) communication. In one aspect, a cranial implant device comprises a hermetically sealed enclosure that includes a lid having a first biocompatible material and a main body having a second biocompatible material different from the first biocompatible material. A set of components is enclosed in the hermetically sealed enclosure. The set of components includes a power delivery coil positioned on a first substrate, distinct from the lid. The power delivery coil is configured to deliver electrical power from an external device to the cranial implant device. The set of components includes one or more antennas positioned on a second substrate, distinct from the lid. The one or more antennas are configured to enable communication with the external device.

### RELATED APPLICATIONS

This application claims priority to (i) U.S. Provisional Application No. 63/783,751, filed Apr. 4, 2025, titled “Antenna Design for Ultra-Wideband Communication on an Implanted Device,” and (ii) U.S. Provisional Application No. 63/783,757, filed Apr. 4, 2025, titled “Power Conserving Methods for Ultra-Wideband on Brain Computer Interface (BCI) Systems,” each of which is incorporated by reference herein in its entirety.

This application is related to U.S. patent application Ser. No. ______ (Attorney Docket Number 141081-5007-US), filed Apr. 1, 2026, titled “Power Conserving Methods for Ultra-Wideband on Brain Computer Interface (BCI) Systems,” which is incorporated by reference herein in its entirety.

### TECHNICAL FIELD

The disclosed embodiments relate generally to brain computer interface (BCI) systems, and more specifically to BCI systems and devices, and methods that utilize ultra-wideband (UWB) communication.

### BACKGROUND

Neurological conditions can result in the loss of communication and autonomy. Brain computer interface (BCI) technologies can assist individuals with neurological impairments, by recording and processing brain signals and translating the signals into outputs.

### SUMMARY

Decoding brain activities in the sensorimotor cortex region requires obtaining neural activity data of a patient at high spatiotemporal resolution using an implant device and transferring the data from the implant device to a computer device for decoding. Some existing approaches require a physical cable connection from the implant device to a nearby computer for data transfer, rendering them inconvenient for use because the patient needs to be physically tethered to the equipment. Other existing approaches focus on transmitting the data wirelessly, to avoid the inconvenience of using a cable. However, wireless transmission of such data through a human scalp tissue is challenging because the human scalp is made up of a combination of fat, skin and blood vessels, which makes its relative permittivity value high compared to that of air. Additional requirements, such as low latency, high bandwidth, low error rates, small footprint, and low power consumption, further exacerbate the complexity of designing such devices. Further, ultra-wideband (UWB) communication technology is a suitable candidate for transferring neural data. However, UWB communication tends to require a larger-sized antenna, which is not practical for the smaller form factor required for medical implant devices.

Some embodiments disclose a cranial implant device that provides a technical solution to the aforementioned technical problems. As disclosed, in some embodiments, the cranial implant device includes a set of electronic components such as an RF power coil and antennas that are placed inside a hermetically sealed, biocompatible enclosure. The antennas include a UWB antenna and a Bluetooth antenna, and are designed to be in capacitive mode. The hermetically sealed enclosure includes a low loss, high electrical permittivity ceramic lid. In some embodiments, the relative permittivity value of the lid is close to that of the scalp, which helps to minimize signal reflection and helps with smoother signal transmission. In some embodiments, the electronic components that are enclosed inside the hermetically sealed enclosure further include a conductive shielding layer that separates the ceramic lid from the main electronics assembly, and a ferrite layer on top of the conductive shielding layer is a ferrite layer. Consequently, most of the capacitive antenna transmission (e.g., desirable antenna radiation) would be radiated in a direction towards the top and out of the implant device toward an external device that is magnetically coupled to the implant device. On the other hand, the inductive mode radiation inside the implant device (e.g., undesirable antenna radiation) would be radiated in a downward direction and be suppressed by the presence of ferrite layer.

As disclosed, in some embodiments, the cranial implant device employs a UWB radio module in addition to a side-band radio module (e.g., Bluetooth or BLE). The UWB radio module allows UWB signals (e.g., raw neural signals) to transmit unidirectionally, while the side-band radio module processes configuration and control requests. Operating the UWB radio module in a transmit-only mode enables the entire capacity of the UWB channel to be used for sending data, which enables more data to be sent and also simplifies the communication process.

In accordance with some embodiments, a cranial implant device comprises a hermetically sealed enclosure including a lid having a first biocompatible material and a main body having a second biocompatible material different from the first biocompatible material. The cranial implant device includes a set of (e.g., one or more) components enclosed in the hermetically sealed enclosure. The set of components includes a power delivery coil positioned on a first substrate, distinct from the lid. The power delivery coil is configured to deliver electrical power from an external device to the cranial implant device. The set of components includes one or more antennas positioned on a second substrate, distinct from the lid. The one or more antennas are configured to enable communication with the external device.

In some embodiments, the first substrate is a first printed circuit board (PCB); and the second substrate is a second printed circuit board (PCB) that is different from the first PCB.

In some embodiments, the one or more antennas comprise an ultra-wideband (UWB) antenna. In some embodiments, the one or more antennas comprise a Bluetooth Low Energy (BLE) antenna. In some embodiments, the one or more antennas comprise a near-field communication (NFC) antenna.

In some embodiments, the set of components includes a spacer component positioned adjacent to the UWB antenna, away from the lid. In some embodiments, the set of components includes a ferrite component positioned immediately adjacent to the spacer component; and the spacer component is between the UWB antenna and the ferrite component. In some embodiments, the arrangement of the ceramic lid, the one or more antennas, the spacer component, the ferrite component, and the shielding component improves wireless communication performance in a compact cranial implant form factor. The ceramic lid can assist operation of the one or more antennas, including a UWB antenna, such that the one or more antennas can be made smaller while maintaining a communication link suitable for high-bandwidth data transfer. The spacer component can maintain separation between the one or more antennas and the ferrite component, thereby reducing dielectric loading and preserving desired antenna characteristics, while also providing mechanical stability to maintain alignment of the internal stack. The ferrite component and the shielding component can cooperate to suppress undesirable downward radiation and reduce reflection back toward the one or more antennas, thereby improving upward radiation toward the scalp and an external wearable device. As a result, the disclosed architecture can improve link reliability and communication efficiency without requiring a larger antenna or a larger implant package.

In some embodiments, the cranial implant device is configured to be anchored to a skull of a patient. The UWB antenna is configured to transmit neural data of the patient to an external device.

In accordance with some embodiments, a cranial implant device comprises a hermetically sealed enclosure including a lid having a first biocompatible material and a main body having a second biocompatible material different from the first biocompatible material. The cranial implant device comprises a set of components enclosed in the hermetically sealed enclosure. The set of components includes an ultra-wideband (UWB) antenna configured to enable communication with an external device. The UWB antenna is positioned on a printed circuit board (PCB) and is configured to be located immediately adjacent to the lid without physically contacting the lid.

In accordance with some embodiments, a cranial implant device comprises an ultra-wideband (UWB) antenna, a Bluetooth Low Energy (BLE) antenna, and a UWB radio module coupled to the UWB antenna. The UWB radio module is configured to transmit short-range, wireless neural data unidirectionally to an external device. The cranial implant device also includes a BLE radio module coupled to the BLE antenna. The BLE radio module is configured to receive and transmit short-range, wireless side band data.

In accordance with some embodiments, a cranial implant device comprises an ultra-wideband (UWB) antenna, a near-field communication (NFC) antenna, and a UWB radio module coupled to the UWB antenna. The UWB radio module is configured to transmit short-range, wireless neural data unidirectionally to an external device. The cranial implant device also includes an NFC module coupled the NFC antenna. The NFC module is configured to receive wireless power signals from the external device.

In some embodiments, the communication architecture also improves power efficiency and usable data throughput. For example, the implant device can transmit raw, unprocessed neural data over a UWB channel in a transmit-only mode while using a side-band channel such as BLE for acknowledgements, configuration, and control. By restricting the UWB path to outbound neural-data transfer, a greater portion of the UWB channel can be used for neural-data communication, thereby reducing communication overhead and lowering implant-side power consumption. In some embodiments, an NFC channel is used for initial power transfer, low-level communication, verification of power-link stability, staged boot of implant subsystems, and recovery operations including firmware update. These features can be particularly beneficial in a battery-less cranial implant that is subject to strict size, power, and thermal constraints.

In accordance with some embodiments, a method for communicating neural data is performed at a brain computer interface (BCI) system that includes a cranial implant device and an external device (e.g., a wearable device). The cranial implant device includes a UWB radio module and a Bluetooth Low Energy (BLE) radio module. The method includes transmitting, via the UWB radio module, short-range, wireless neural data unidirectionally to the external device. The method includes receiving, via the BLE radio module, short-range wireless interaction data from the external device. The method also includes transmitting, via the BLE radio module, feedback data to the external device.

In accordance with some embodiments, a method for booting (e.g., initializing) a cranial implant device comprises receiving, via a near-field communication (NFC) module of the cranial implant device, an NFC signal from an external device. The method comprises powering at least a portion of the cranial implant device using the NFC signal. The method comprises establishing initial communication with the external device over an NFC channel. The method comprises communicating with the external device over the NFC channel. The method comprises verifying, based on the communicating, that a wireless power-delivery link between the external device and the cranial implant device satisfies a stability criterion. The method comprises, in response to verifying that the wireless power-delivery link satisfies the stability criterion, enabling higher-level communication circuitry of the cranial implant device.

In accordance with some embodiments, a method for recovering operation of a cranial implant device comprises operating a near-field communication (NFC) channel between the cranial implant device and an external device after initialization of the cranial implant device. The method comprises, in response to a Bluetooth Low Energy (BLE) channel becoming unavailable or higher-level firmware becoming corrupted, receiving a firmware update through the NFC channel alone. The method comprises updating executable code of the cranial implant device based on the firmware update.

In accordance with some embodiments, a brain computer interface (BCI) system comprises a cranial implant device that includes a UWB radio module and a Bluetooth Low Energy (BLE) radio module. The BCI system includes an external device. The BCI system also includes processing circuitry. The processing circuitry is configured to transmit, via the UWB radio module, short-range, wireless neural data unidirectionally to the external device. The processing circuitry is configured to receive, via the BLE radio module, short-range wireless interaction data from the external device. The processing circuitry is configured to transmit, via the BLE radio module, feedback data to the external device.

In accordance with some embodiments, a brain computer interface (BCI) system comprises a cranial implant device. The cranial implant device includes a UWB radio module, a Bluetooth Low Energy (BLE) radio module, and a near-field communication (NFC) module. The BCI system includes a wearable device including a complementary UWB radio module, BLE communication circuitry, and an NFC reader. The cranial implant device is configured to transmit neural data to the wearable device via the UWB radio module, receive wireless power from the wearable device via the NFC module, and exchange control data with the wearable device via the BLE radio module.

In accordance with some embodiments, a brain computer interface (BCI) system includes a cranial implant device. In some embodiments, the BCI system includes an external device. In some embodiments, the external device comprises a wearable device. The BCI system includes processing circuitry (e.g., one or more processors) and memory storing one or more programs. The one or more programs include instructions, which when executed by the processing circuitry, cause the BCI system to perform any of the methods disclosed herein.

In accordance with some embodiments, a computing device includes one or more processors and memory coupled to the one or more processors. The memory stores one or more programs configured for execution by the one or more processors. The one or more programs include instructions for performing any of the methods disclosed herein.

In accordance with some embodiments, a computer system includes one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing device having a display, one or more processors, and memory. The one or more programs include instructions for performing any of the methods disclosed herein.

In accordance with some embodiments, a non-transitory computer readable storage medium stores one or more programs configured for execution by a computer system having one or more processors, and memory. The one or more programs include instructions for performing any of the methods disclosed herein.

Thus systems, devices, and methods are disclosed that utilize antennas for ultra-wideband (UWB) communication on an implanted device of a BCI.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, reference should be made to the Detailed Description of Embodiments below, in conjunction with the following drawings in which like reference numerals refer to corresponding parts throughout the figures. The accompanying drawings, which are included to provide a further understanding of the embodiments, are incorporated herein, constitute a part of the specification, illustrate the described embodiments, and, together with the description, serve to explain the underlying principles.

FIG. 1A illustrates an example operating environment, in accordance with some embodiments.

FIG. 1B illustrates example operating modes of a computing device, in accordance with some embodiments.

FIG. 1C is a graph showing an actual time-series dataset of neural activity of a patient, in accordance with some embodiments.

FIG. 1D is a graph showing neural features extracted from the neural activity dataset of FIG. 1C, in accordance with some embodiments.

FIGS. 2A, 2B, and 2C illustrate an example implant device, in accordance with some embodiments.

FIG. 2D is a block diagram showing an example data path, control path, and power path of an implant device, in accordance with some embodiments.

FIG. 3A illustrates an example wearable device, in accordance with some embodiments.

FIG. 3B is a block diagram showing an example data path, control path, and power path of a wearable device, in accordance with some embodiments.

FIG. 4 is a block diagram illustrating an example computing device in accordance with some embodiments.

FIG. 5 is a block diagram illustrating an example server system in accordance with some embodiments.

FIGS. 6A to 6E illustrate various views of an implant device, in accordance with some embodiments.

FIG. 7 is a block diagram illustrating data communication between an implant device, a wearable device, and a computing device, in accordance with some embodiments.

FIG. 8 is a flowchart of an example process for neural data communication, in accordance with some embodiments.

FIG. 9 is a flowchart of an example process for booting a cranial implant device, in accordance with some embodiments.

FIG. 10 is a flowchart of an example process for recovering operation of a cranial implant device, in accordance with some embodiments.

Like reference numerals refer to corresponding parts throughout the several views of the drawings.

### DETAILED DESCRIPTION OF EMBODIMENTS

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

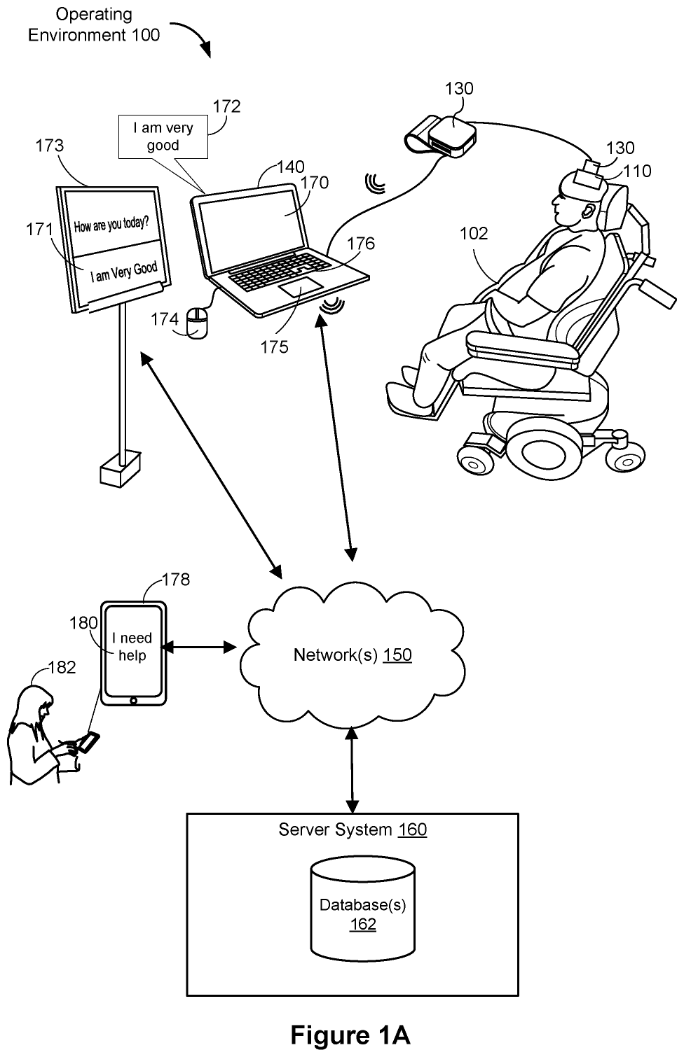

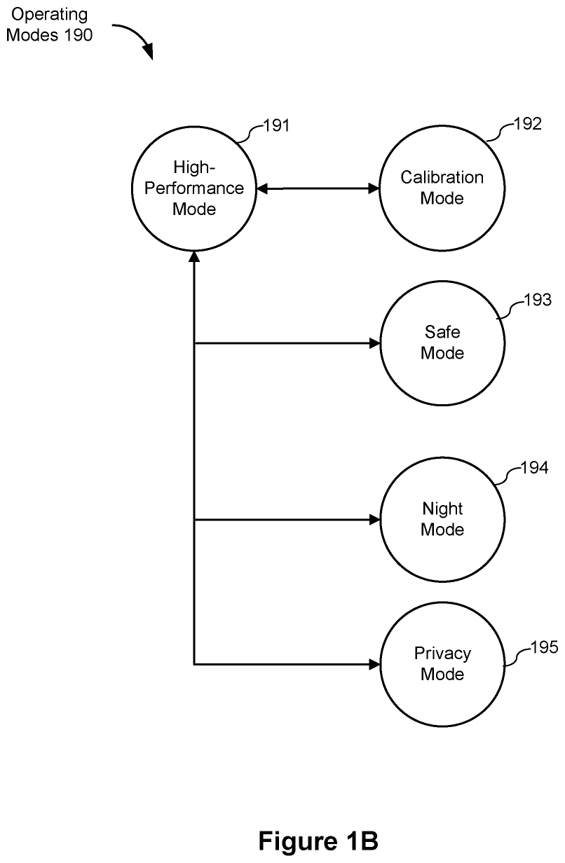

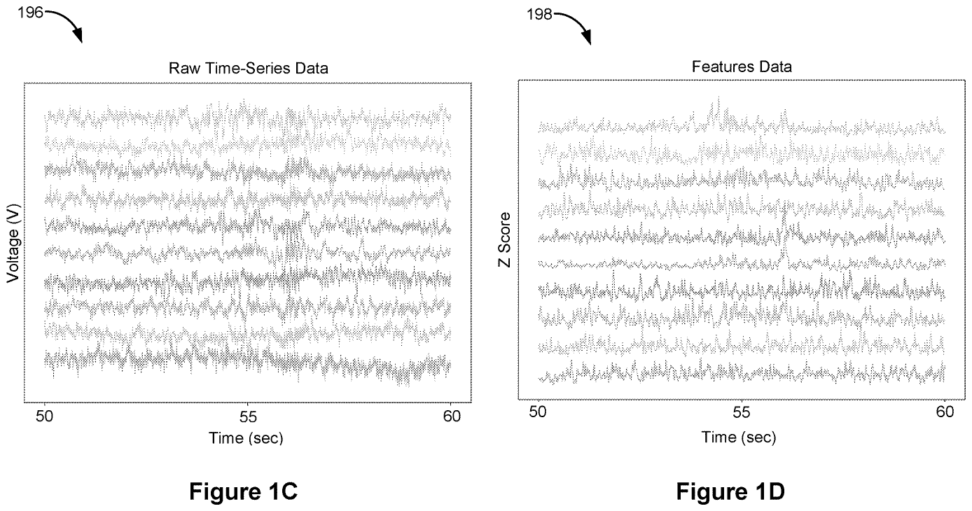

FIG. 1A illustrates an example operating environment 100 of a brain computer interface (BCI) system, in accordance with some embodiments.

As used herein, a BCI system is a system that acquires brain signals from a user and determines, from the signals, into one or more intended actions (e.g., functional intents) of the user. In some embodiments, the BCI system generates and executes commands for controlling one or more external devices without requiring traditional muscle movements of the user. Because no user movement or vocalization is required to control the BCI system, the BCI system can assist users with disabilities, thereby enhancing the user's capabilities and improving their quality of life.

The operating environment 100 depicts a human subject 102. As used herein, human subject 102 is also referred to as a “patient” or a “user.” In some instances, the human subject 102 is unable to speak or unable to move their limbs. In some embodiments, the BCI system includes an implant device 110 (also referred to herein as a cranial implant device), which is implanted into the skull of the human subject 102. The implant device 110 includes an array of high-density electrode sensors for recording neural signals (e.g., electrical signals) corresponding to motor cortex activity directly from the brain surface of the human subject 102. In some embodiments, the array is a brain-penetrating electrode array or an electrocorticography (ECoG) electrode array. In some embodiments, the electrodes are depth electrodes or surface electrodes. In some embodiments, the recorded neural signals represent specific activities of the brain, including attempted speech, attempted movement, hearing, and/or vision. In some embodiments, the array of electrode sensors are placed on the cortical surface of the brain, either epidurally or subdurally, to record signals directly from the brain. In some embodiments, the array of electrode sensors can penetrate under the scalp.

In some embodiments, the BCI system includes a wearable device 130. As described in further detail in FIG. 3A, in some embodiments the wearable device 130 includes a patch component that is magnetically and communicatively coupled to the implant device 110. The patch component is configured to transmit power wirelessly into the implant device 110 and receive neural signal data from the implant device 110. In some embodiments, the wearable device 130 includes a relay component that includes electronics for supporting the functionalities of the patch component.

In some embodiments, the BCI system includes a computing device 140 that is communicatively connected with the wearable device 130. The computing device 140 can include a display 170, a keyboard 176 and a pointing device such as a mouse 174 or a touchpad 175. In accordance with some embodiments, the computing device 140 functions as the main interface for the human subject 102. For example, the human subject 102 can access one or more applications executing on the computing device 140 for their daily tasks and activities such as checking email and browsing the web. In some embodiments, the one or more applications executing on the computing device 140 includes a BCI application (e.g., application 440) that is configured to decode the neural signals and interpret the decoded signals to determine one or more intended actions (e.g., functional intents) of the human subject 102. In some embodiments, the BCI application applies one or more machine learning models that are stored locally on the computing device 140 to perform the decoding and interpreting. In some embodiments, the BCI application is configured to execute on the computing device 140 even while the computing device 140 is offline (although an internet connection will be required to receive new models from the server system 160).

In some embodiments, the BCI system includes a server system 160 that is communicatively coupled to the computing device 140 through one or more communication networks 150. The server system 160 includes an operational pipeline that is configured to automatically generate different machine learning models based on respective input data, train the models to optimize their performance on specific tasks, and deploy the models locally on respective computing devices 140. In some embodiments, the server system 160 includes one or more databases 162 for storing data such as raw data obtained from implanted devices corresponding to respective patients, feature data, analytics data, application information, and firmware versions.

With continued reference to FIG. 1A, in some embodiments, the BCI system is configured to control one or more output devices to carry out one or more intended actions of the human subject 102 according to the decoded signals. As one example, in some embodiments, the BCI system (e.g., computing device 140 or server system 160) is configured to control a keyboard (e.g., physical keyboard 176 or a virtual keyboard) to generate language and/or numeral outputs according to the decoded signals (e.g., by typing letters, numbers, words and/or sentences using the keyboard), without requiring any voice command and/or limb movement by the human subject 102. As another example, in some embodiments, the BCI system is configured to control a cursor (e.g., by controlling a pointing device such as mouse 174, touchpad 175, or the cursor) according to the decoded signals, without requiring any voice command and/or limb movement by the human subject 102. As another example, in some embodiments, the BCI system is configured to control a display device (e.g., display 170 or external display device 173) to display a visual output (e.g., text entry 171) corresponding to a response from the human subject 102, without requiring any voice command and/or limb movement by the human subject 102. As another example, in some embodiments, the BCI system is configured to translate a visual/text output into a verbal expression and generate an audio output 172 articulating the verbal expression using an audio output component of the computing device 140, without requiring any voice command and/or limb movement by the human subject 102. As another example, in some embodiments, the BCI system is configured to control one or more interfaces of the computing device 140 to navigate through menus and/or switch between tabs of one or more applications executing on the computing device 140, without requiring any voice command and/or limb movement by the human subject 102. As yet another example, in some embodiments, the BCI system is configured to generate an alert according to the decoded signals and transmit the alert to an electronic device 178 that is associated with a caregiver 182 of the human subject 102, for display (e.g., as alert message 180) on a display screen of the electronic device 178.

FIG. 1B illustrates example operating modes 190 of a computing device 140, in accordance with some embodiments.

In accordance with some embodiments, the computing device 140 can switch between various operating modes. A respective operating mode may have its associated (e.g., distinct) user interface. A human subject 102 may interact with the computing device 140 in specific ways, depending on the operating mode.

Referring to FIG. 1B, in some embodiments, the operating modes include a high performance mode 191 that allows a human subject 102 to fully interact with the computing device 140. For example, in the high performance mode 191, the human subject 102 has access to all functionalities of applications that are executing on the computing device. In some embodiments, the high performance mode 191 is also referred as the “normal” mode. In some embodiments, high performance mode 191 is the default operating mode of the computing device.

In some embodiments, the operating modes include a calibration mode 192, which is a sandbox mode used during training tasks.

In some embodiments, the operating modes include a safe mode 193. In some embodiments, the safe mode 193 is a fallback mode for when the high performance mode 191 is not available.

In some embodiments, the operating modes include a night mode 194. When operating in the night mode, the display screen 170 of the computing device 140 is not in use and the computing device 140 has limited functionality due to the screen not being in use.

In some embodiments, the operating modes include a privacy mode 195, where brain signals are not recorded and not decoded.

FIG. 1C is a graph 196 showing an actual raw time-series dataset of neural activity of a patient collected by an electrode array, in accordance with some embodiments. The dataset is collected by placing electrodes on the surface of the patient's brain. Each of the line plots in the graph 196 corresponds to electrical field signals collected by a respective channel (e.g., an electrode) of the array. The line plots on the graph 196 have been offset for clarity.

FIG. 1D is a graph 198 showing a neural-feature time-series dataset extracted from the neural activity data of FIG. 1C, in accordance with some embodiments. In some embodiments, the neural-feature time series dataset is generated using a feature processing pipeline that is executed by the computing device 140 (e.g., application 440) or the server system 160 (e.g., operational pipeline 524). The neural features correspond to representations of brain signals that contain information related to underlying neural processing, including neural representations associated with attempted speech and/or motor movements. The values on the y-axis of the graph 198 are z-score values, which are normalized values that indicate how many standard deviations a data point is from the mean of the dataset (computed individually for each feature time series).

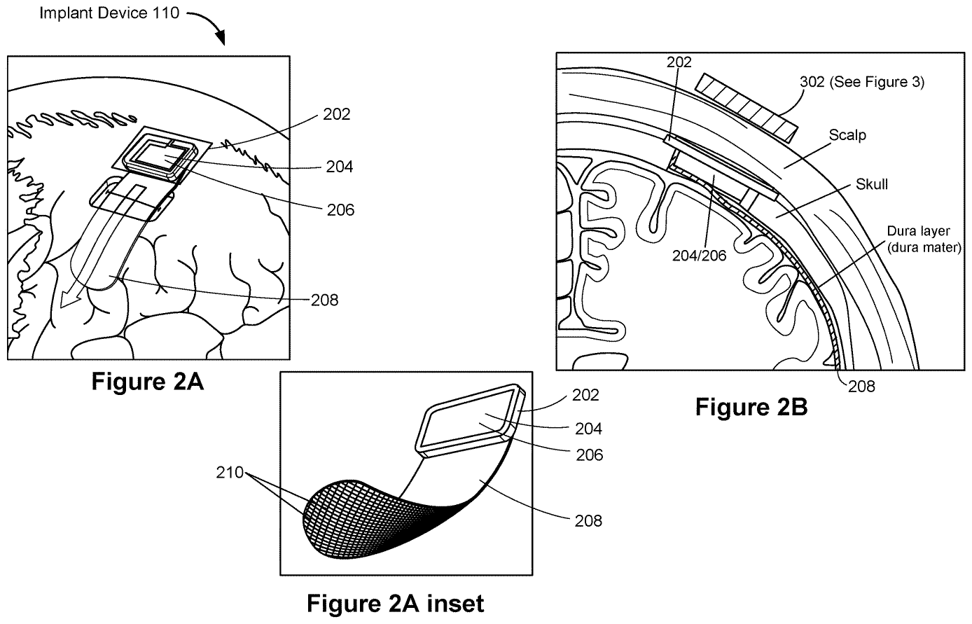

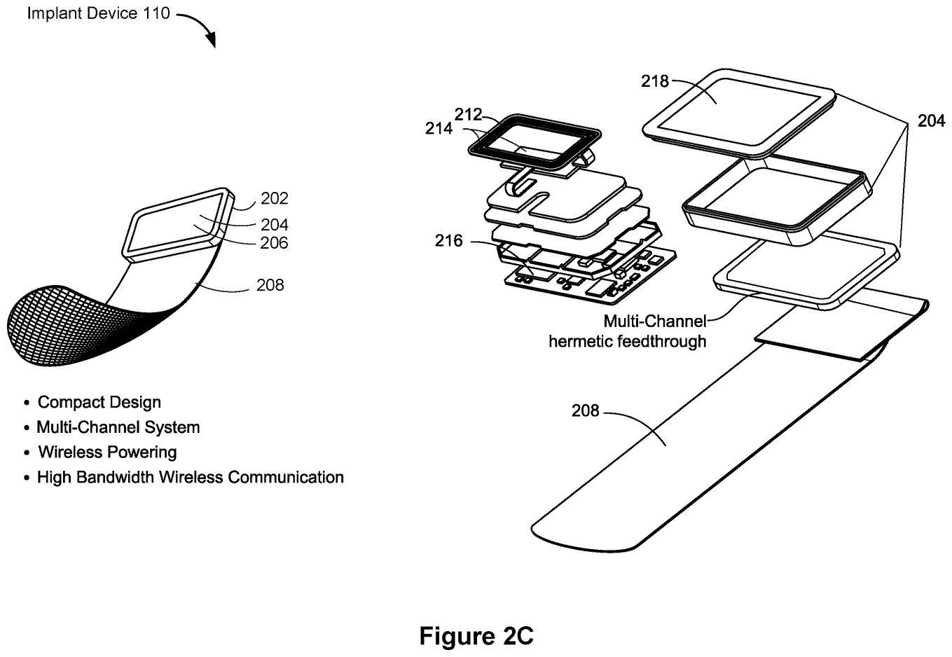

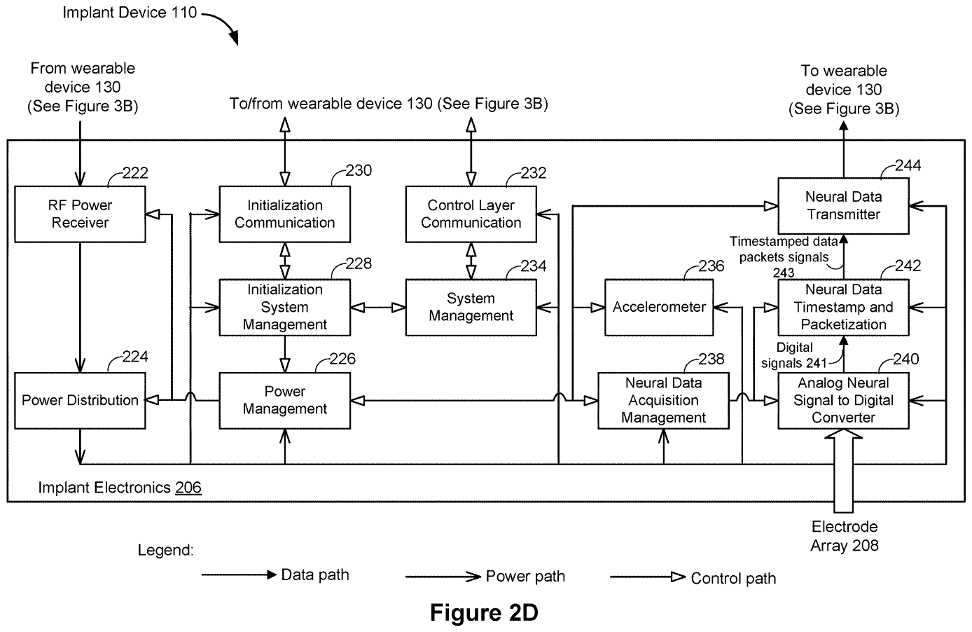

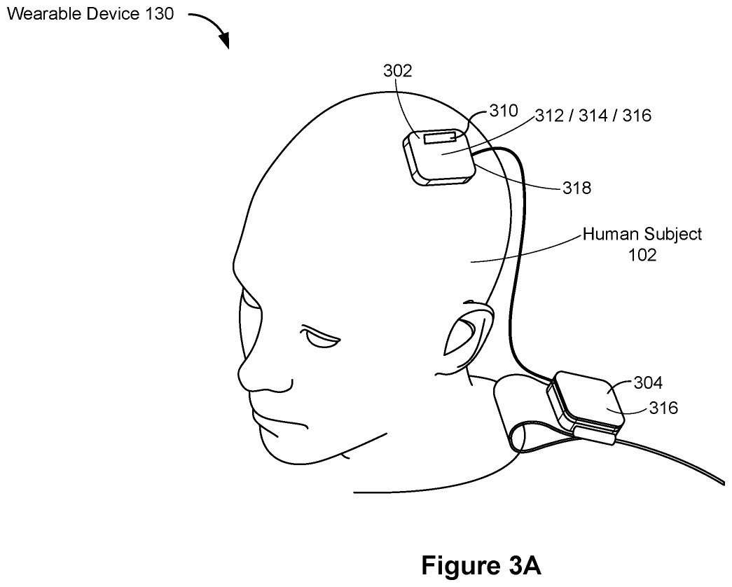

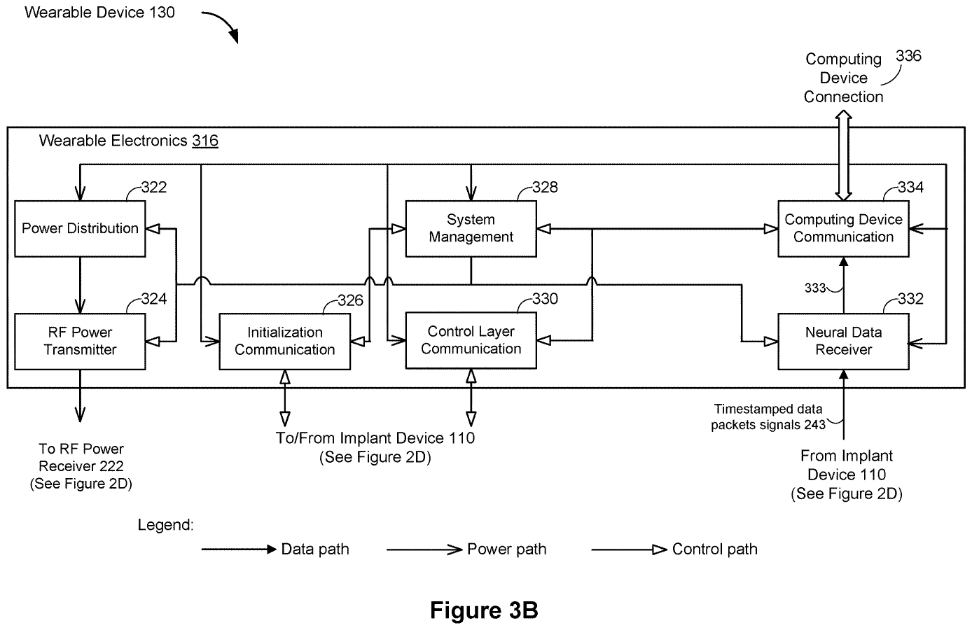

FIGS. 2A, 2B, and 2C illustrate various views of the implant device 110, in accordance with some embodiments.

In some embodiments, the implant device 110 includes a frame 202, a hermetic package 204 (e.g., hermetically-sealed package), implant electronics 206 (e.g., one or more electronic components) enclosed in the hermetic package 204, and an electrode array 208. As used herein, the electrode array 208 is also referred to as “an array of electrodes” or “an array of electrode sensors.” FIG. 2A inset shows that the electrode array 208 comprises a thin, flexible array (e.g., with a thickness of around 50 μm to 200 μm) that includes multiple electrode sensors 210. In some embodiments, the electrode array 208 comprises an electrocorticography (ECoG) array that is surgically implanted on the brain's surface.

In some embodiments, the electrode array 208 includes at least 100 electrodes, at least 250 electrodes, at least 500 electrodes, at least 750 electrodes, at least 1000 electrodes, at least 1500 electrodes, at least 2000 electrodes, at least 2500 electrodes, at least 3000 electrodes, at least 4000 electrodes, at least 5000 electrodes, at least 7500 electrodes, or at least 10,000 electrodes. In some embodiments, the electrode array 208 is designed to be placed over a substantial portion of or the entire sensorimotor cortex region, to collect electrophysiologic data with information content of intended speech and movement of a human subject. In some embodiments, the electrode array is designed to be placed over one or more subregions or regions of the cortex, such as the precentral gyrus, postcentral gyrus, posterior superior frontal gyrus, posterior middle frontal gyrus, posterior inferior frontal gyrus region, superior temporal gyrus, or a combination of any of the foregoing. Typically, each electrode 210 of the electrode array 208 corresponds to a channel and is configured to pick up electrical activity from the cortex. A denser electrode array with higher channel count can capture more signals with higher fidelity, which can be used to decode intended actions (e.g., intended speech actions and non-speech actions) of the human subject.

FIG. 2B illustrates a coronal cross-sectional view of a brain of a human subject. In some embodiments, the frame 202 is configured to be anchored to a skull of a human subject 102 via a surgical procedure called craniectomy, in which a scalp incision is made and a full-thickness section of bone is removed from the skull. In the example of FIG. 2B, the frame 202, the hermetic package 204, and the implant electronics 206 are configured to be positioned above the dural layer (e.g., closer to the scalp), whereas the electrode array 208 is inserted into the sub-dural layer (e.g., underneath the dura mater) of the brain of the human subject 102. During device operation, the electrode array 208 is configured to acquire (e.g., record) motor cortex neural signals (e.g., electrical signals) from the brain of the human subject.

In some embodiments, the implant device 110 includes a battery. In some embodiments, the implant device 110 does not include a battery. In some embodiments, the implant device 110 is configured to receive power signals from a patch component 302 of the wearable device 130. In some embodiments, the implant electronics 206 include a wireless powering coil 212 that is configured to receive electrical power wirelessly from the patch component 302. In some embodiments, the hermetic package 204 includes a cover 218 that is composed of a ceramic material or other dielectric material to facilitate the receiving of power signals via inductive coupling or capacitive coupling. In some embodiments, the wireless powering coil 212 is configured to receive constant electrical power from the patch component 302.

FIG. 2B illustrates coupling between the implant device 110 and the patch component 302. In some embodiments, the frame 202 includes one or more magnets that are configured to magnetically couple to one or more complementary magnets positioned at the patch component 302.

In some embodiments, the implant electronics 206 include a wireless communication antenna 214 that is configured to establish a direct wireless link between the implant device 110 and the wearable device 130. In some embodiments, the wireless communication antenna 214 is configured to implement high bandwidth wireless communication to transmit the multiple channels (e.g., hundreds or thousands of channels) of brain signals (e.g., electrical signals) that are collected by the electrode array 208 to the wearable device 130. In some embodiments, the implant device 110 is configured to amplify, digitize, and transmit the signals to the patch component 302 as data packets without interpreting and/or further processing the signals.

In some embodiments, the implant electronics 206 include processing circuitry, communication circuitry, and power circuitry. In some embodiments, the various circuitries are implemented as a multi-channel application-specific integrated circuit (ASIC) chip 216 that enables custom programming of specific tasks. In some embodiments, the ASIC chip 216 is implemented as a system-on-chip (SOC). In some embodiments, the ASIC chip 216 and includes one or more microprocessors and one or more memory blocks such as ROM, RAM, EEPROM, flash memory, or other building blocks.

FIG. 2D is a block diagram showing an example data path (represented by closed triangle arrows), power path (represented by two-edged arrows), and control path (represented by open triangle arrows) of an implant device 110, in accordance with some embodiments.

The data path of the implant device 110 includes receiving neural signals from the electrode array 208. In some embodiments, the implant device 110 includes an analog neural signal to digital converter module 240 (e.g., an analog to digital converter) for converting the neural signals (e.g., electrical signals) from analog form to digital form (e.g., digital signals 241). The implant device 110 includes a neural data timestamp and packetization module 242 for embedding date/time information to the digital signals and breaking down the digital signals into data packets (e.g., data segments) of smaller data sizes (e.g., timestamped data packets 243). The implant device 110 includes a neural data transmitter module 244 for transmitting the timestamped data packets 243 to the wearable device 130.

In accordance with some embodiments, the implant device 110 does not include a battery (i.e., the implant device 110 is not a battery-operated device). In some embodiments, the implant device 110 receives its power supply from the wearable device 130. In some embodiments, the implant device 110 includes an RF power receiver module 222 for receiving power (e.g., DC power) from the wearable device 130 (e.g., from RF power transmitter module 324 of the wearable device 130) and sending the received power to a power distribution module 224. The power distribution module 224 is configured to distribute the power to the various modules of the implant device 110, including the analog neural signal to digital converter module 240, the neural data timestamp and packetization module 242, the neural data transmitter module 244, a power management module 226, an initialization system management module 228, an initialization communication module 230, a control layer communication module 232, a system management module 234, an accelerometer module 236, and a neural data acquisition module 238.

In some embodiments, the power management module 226 is configured to actively control and monitor the flow of electrical power within the implant device 110. For example, the power management module 226 can regulate voltage, manage current draw, and protect modules such as the neural data acquisition module 238, the analog neural signal to digital converter module 240, the neural data timestamp and packetization module 242, the neural data transmitter module 244, and the accelerometer module 236 against overloads, thus ensuring efficient and safe power distribution to modules or components of the implant device 110.

In some embodiments, the initialization system management module 228 is configured to handle the initialization process when the implant device 110 first starts up, by coordinating the loading and configuration of settings and modules, such as the initialization communication module 230, the system management module 234, and the power management module 226.

In some embodiments, the initialization communication module 230 is configured to set up and prepare the communication channels and protocols needed for the implant device 110 to interact with the wearable device 130 at the beginning of its operation.

In some embodiments, the control layer communication module 232 is configured to manage the flow of data between different modules of the implant device 110 and between the implant device 110 and the wearable device 130.

In some embodiments, the system management module 234 is configured to manage and monitor the performance, health, and operation of the implant device 110. For example, the system management module 234 can track system parameters such as temperature, voltage, and power consumption to ensure stable operation of the implant device 110. In some instances, the system management module 234 can identify system failures, log errors, and provide alerts for troubleshooting.

In some embodiments, the accelerometer module 236 (e.g., hardware accelerator) is specifically designed to significantly speed up the execution of specific tasks by offloading them from the main processor of the ASIC chip 216.

In some embodiments, the neural data acquisition module 238 is configured to record electrical activity from the brain (e.g., neurons) using electrodes 210 of the electrode array 208. In some embodiments, the neural data acquisition module 238 is configured to acquire the electrical activity without performing additional processing on the recorded data. In some embodiments, the neural data acquisition module 238 is configured to boost weak neural signals. In some embodiments, the neural data acquisition module 238 is configured to filter out noise and unwanted frequencies to improve signal quality.

FIG. 3A illustrates a wearable device 130, in accordance with some embodiments. In some embodiments, the wearable device 130 includes a patch component 302, a relay component 304, and wearable electronics 316 (e.g., electronic components).

In some embodiments, the patch component 302 includes one or more magnets 310 that are configured to magnetically couple and align the patch component 302 to the implant device 110. In some embodiments, the patch component 302 includes one or more coils 312 and/or antenna 314 for transmitting power wirelessly into the implant device 110, transmitting command signals into the implant device 110, and/or receiving neural signal data transmitted from the implant device 110. In some embodiments, the patch component 302 includes wearable electronics 316 (e.g., electronic components) (e.g., to power the coils 312 and/or the antennas 314. In some embodiments, the patch component 302 includes a mechanical housing 318 for holding the magnets 310 the coils 312, the antenna 314, and/or the wearable electronics components 316.

In some embodiments, the relay component 304 includes additional electronics for supporting functionalities of the patch component 302, and for enabling data and power transfer between the patch component 302 and the computing device 140. In some embodiments, the relay component 304 is configured to anchor the wearable device 130 on or near the human subject 102, such as on clothing worn by the human subject, or on a wheelchair or mobility device of the human subject, or on a patient bed of the human subject.

FIG. 3B is a block diagram showing an example data path (represented by closed triangle arrows), power path (represented by two-edged arrows), and control path (represented by open triangle arrows) of a wearable device 130, in accordance with some embodiments.

Data path-wise, in some embodiments, the wearable device 130 includes a neural data receiver module 332 for receiving neural signals in the form of timestamped data packets 243 from the implant device 110. In some embodiments, the neural data receiver module 332 generates packetized combined data 333 by further packetizing the timestamped data packets 243 along with data from the wearable device 130 and control commands. The neural data receiver module 332 transmits the packetized combined data 333 to a computing device communication module 334 that is configured to transmit the packetized combined data 333 to the computing device 140 via a connection 336 of the computing device.

The wearable device 130 is connected to an electrical power source. For example, the wearable device 130 can be connected to an electrical power outlet or can include an energy storage device and/or a battery that is configured to supply power to the wearable device 130. In some embodiments, the wearable device 130 includes a RF transmitter module 324 that is configured to transmit electrical power to the implant device 110 (e.g., to the RF power distribution module 322). Ad depicted in FIG. 3B, the electrical power source of the wearable device 130 is configured to provide power to various modules of the wearable electronics 316, including an initialization communication module 326, a system management module 328, a control layer communication module 330, the neural data receiver module 332, and the computing device communication module 334.

In some embodiments, the initialization communication module 326 is configured to set up and prepare the communication channels and protocols needed for the wearable device 130 to interact with the implant device 110 at the beginning of its operation.

In some embodiments, the system management module 328 is configured to manage and monitor the performance, health, and operation of the wearable device 130. For example, the system management module 328 can track system parameters such as temperature, voltage, and power consumption to ensure stable operation of the wearable device 130. In some instances, the system management module 328 can identify system failures, log errors, and provide alerts for troubleshooting.

In some embodiments, the control layer communication module 330 is configured to manage the flow of data between different modules of the wearable device 130 and between the wearable device 130 and the implant device 110.

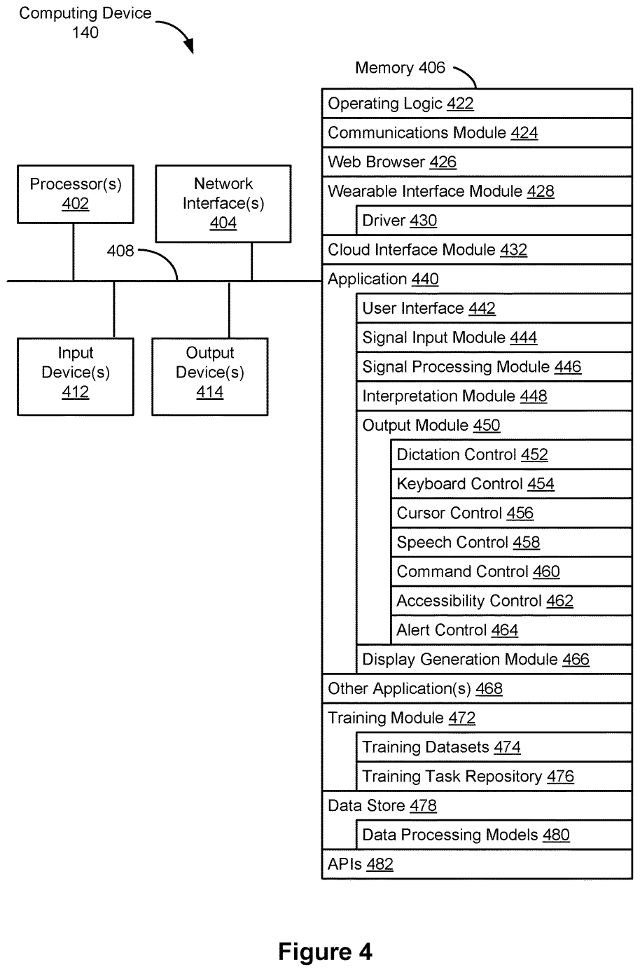

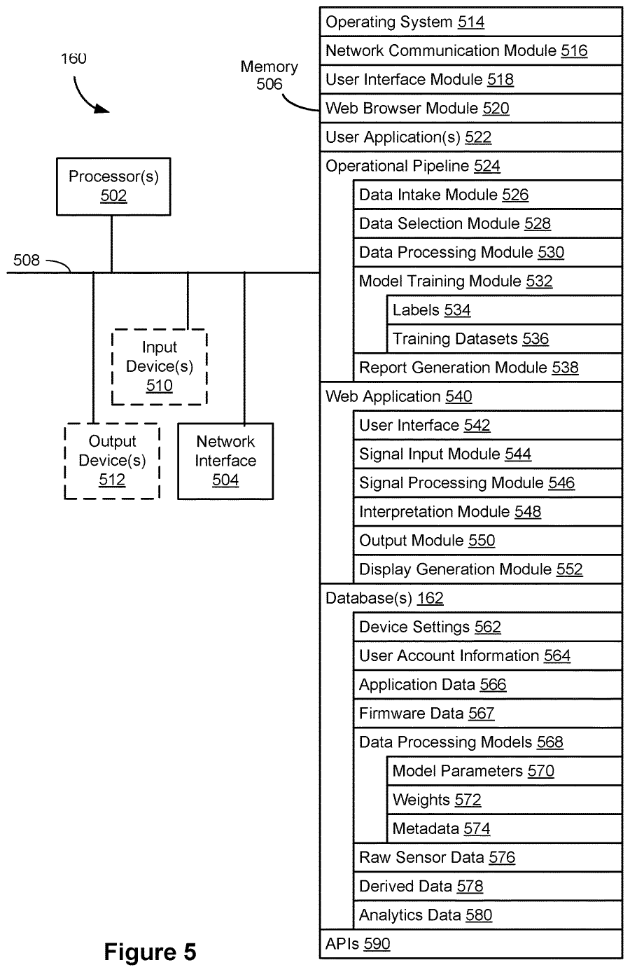

FIG. 4 is a block diagram illustrating a computing device 140, in accordance with some embodiments. Various examples of the computing device 140 include a desktop computer, a laptop computer, a tablet computer, a virtual reality (VR) device, an augmented reality (AR) device, or a spatial computing device that blends digital content with the physical world. The computing device 140 includes one or more processors 402 (e.g., processing units (CPUs) or cores), one or more network or communication interfaces 404, memory 406, and one or more communication buses 408 for interconnecting these components. In some embodiments, the communication buses 408 include circuitry (sometimes called a chipset) that interconnects and controls communications between system components. In some embodiments, the computing device 140 includes a user interface 410. The user interface 410 typically includes a display (e.g., display device) 412.

In some embodiments, the computing device 140 includes one or more input devices 412, which facilitate user input, such as a keyboard, a mouse, a voice-command input unit or microphone, a display 170 (e.g., which can be a touch-sensitive display), a touch-sensitive input pad, a gesture capturing camera, or other input buttons or controls. In some embodiments, the computing device 140 uses a microphone and voice recognition or a camera and gesture recognition to supplement or replace the keyboard. In some implementations, the computing device 140 includes one or more cameras, scanners, or photo sensor units for capturing images. In some embodiments, the computing device 140 includes one or more output devices 414, which enable presentation of user interfaces and display content, including one or more speakers and/or one or more visual displays.

The memory 406 includes high-speed random-access memory, such as DRAM, SRAM, DDR RAM, or other random-access solid-state memory devices. In some embodiments, the memory 20406 6 includes non-volatile memory, such as one or more magnetic disk storage devices, one or more optical disk storage devices, one or more flash memory devices, or one or more other non-volatile solid state storage devices. In some embodiments, the memory 406 includes one or more storage devices remotely located from the processors 402. The memory 406, or alternatively the non-volatile memory devices within the memory 406, includes a non-transitory computer-readable storage medium. In some embodiments, the memory 406, or the computer-readable storage medium of the memory 406, stores the following programs, modules, and data structures, or a subset or superset thereof:
an operating system 422, which includes procedures for handling various basic system services and for performing hardware dependent tasks;
a communications module 424, which connects the computing device 140 to other devices (e.g., various servers in the server system 160, implant device 110, wearable device 130, external display device 173, and mouse 174) via one or more network interfaces 404 (wired or wireless) and one or more networks 150, such as the Internet, other wide area networks, local area networks, metropolitan area networks, and so on;
a web browser 426 (or other application capable of displaying web pages), which enables a user to communicate over a network with remote computers or devices;
a wearable interface module 428, for interfacing with various modules and components of the wearable device 130. In some embodiments, the wearable interface module 428 includes:
   a driver 430, which provides two-way telemetry between the computing device and the wearable device 130 and data input for application 440;
a cloud interface module 432, for providing two-way communication between the computing device 140 and the server system 160;
an application 440. In some embodiments, the application 440 includes:
   a user interface 442 for providing visual information to users and for capturing user inputs;
   a signal input module 444 for receiving brain signals (e.g., electrical signals or data streams) of a human subject 102. As discussed with reference to FIGS. 1, 2, and 3, in some embodiments, the brain signals are collected by implant device 110 and transmitted to the wearable device 130. In some embodiments, the brain signals include attempted or intended speech signals (e.g., the human subject 102 tries to speak, thereby producing electrical signals corresponding to the intended movement of specific individual muscles or groups of muscles used for speech articulation, but their speech may not be vocalized due to underlying pathology preventing correct movement of the intended muscles or muscle groups). In some embodiments, the brain signals include attempted non-speech motor signals, such as attempted head, arm, hand, foot or leg movement signals (e.g., the human subject 102 tries to move their head or limbs, thereby producing electrical signals corresponding to the intended movement of specific individual muscles or groups of muscles used for the desired movement, but actual, physical movement may or may not occur due to underlying pathology preventing correct movement of the intended muscle or muscle groups) and attempted gestures (e.g. a hand squeeze or gesture);
   a signal processing module 446 for decoding the brain signals, including extracting electrophysiological features from the brain signals and performing signal processing functions. The extracted features represent brain activities intended for desired actions. In some embodiments, the signal processing module 446 analyzes signal characteristics such as amplitude, latency of event-evoked potentials, frequency power spectra (e.g., sensorimotor rhythms), or neuronal firing rates, in time-domain and/or frequency-domain. In some embodiments, the signal processing module 446 applies mathematical operations to enhance, filter, or modify the signals, allowing for better interpretation and utilization of the data;
   an interpretation module 448 (e.g., decoding module) for decoding the brain signals by recognizing patterns of the extracted features and the intended actions they represent. In some embodiments, the interpretation module 448 implements a classification process to recognize patterns in the extracted features. In some embodiments, the interpretation module 448 applies one or more machine learning models (e.g., data processing models 480 and/or data processing models 568) to decode the brain signals and determine intended actions of the human subject 102. In some embodiments, the interpretation module 448 applies a machine learning algorithm to decode the brain signals and determine intended actions of the human subject 102. In some embodiments, the machine learning algorithm is associated with the one or more machine learning models. In some embodiments, the interpretation module 448 is configured to generate a respective distinct set of intended actions depending on the operating mode (e.g., operating modes 190) of the computing device. In some embodiments, the interpretation module 448 is configured to translate and/or transform the classified features into actual commands;
   an output module 450 for controlling one or more devices, applications, and/or application interfaces to execute the one or more intended actions. In some embodiments, the output module 450 is configured to control the one or more devices, applications, and/or application interfaces to perform dictation control 452, keyboard control 454, cursor control 456, speech control 458, command control 460, accessibility control 462, and alert control 464. In some embodiments, the output module 450 is configured to control an external robotic arm. In some embodiments, the output module 450 is configured to control a prosthetic limb of the human subject 102; and
   a display generation module 466 for generating visual outputs for display on a display device such as a display screen 170 of the computing device 140 of an external display device 173;
one or more other applications 468 that are executed on the computing device 140, Exemplary applications can include a messaging application, an email application, a data presentation and communication application;
a training module 472 for performing limited machine learning model training. In some embodiments, the server system 160 is configured to train one or more machine learning models (e.g., decoding models) that are deployed locally on the computing device 140. In some embodiments, limited model training occurs locally on the computing device 140. In some embodiments, the training module 472 includes:
   one or more training datasets 474; and
   a training task repository 476, which includes training activities or tasks for training the models one or more data processing models 480.
a data store 478 for storing data associated with the computing device 140, including:
   one or more data processing models 480 (e.g., machine learning models, machine learning algorithms, decoding models, and/or decoding algorithms) for supporting the functions performed by the signal processing module 446 and/or the interpretation module 448. As used herein, a data processing model 480 can refer a machine learning model or an algorithm; and
APIs 482 for receiving API calls from one or more applications (e.g., a web browser 426, application 440, other applications 468), translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 406 stores a subset of the modules and data structures identified above. Furthermore, the memory 406 may store additional modules or data structures not described above. In some embodiments, a subset of the programs, modules, and/or data stored in the memory 406 is stored on and/or executed by a server system 160.

Although FIG. 4 shows a computing device 140, FIG. 4 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 140 may be stored or executed on a server system 160.

FIG. 5 is a block diagram of a server system 160, in accordance with some embodiments. The server system 160 typically includes one or more processors 502 (e.g., processing units or cores (CPUs)), one or more network interfaces 504, memory 506, and one or more communication buses 508 for interconnecting these components (sometimes called a chipset). In some embodiments, the server system 160 includes one or more input devices 510, which facilitate user input, such as a keyboard, a mouse, a voice-command input unit or microphone, a touch screen display, a touch-sensitive input pad, a gesture capturing camera, or other input buttons or controls. In some embodiments, the server system 160 uses a microphone and voice recognition or a camera and gesture recognition to supplement or replace the keyboard. In some implementations, the server system 160 includes one or more cameras, scanners, or photo sensor units for capturing images. In some implementations, the server system 160 includes one or more output devices 512, which enable presentation of user interfaces and display content, including one or more speakers and/or one or more visual displays.

The memory 506 includes high-speed random access memory, such as DRAM, SRAM, DDR RAM, or other random access solid state memory devices. In some implementations, the memory 506 includes non-volatile memory, such as one or more magnetic disk storage devices, one or more optical disk storage devices, one or more flash memory devices, or one or more other non-volatile solid state storage devices. In some implementations, the memory 506 includes one or more storage devices remotely located from the processing units 502. The memory 506, or alternatively the non-volatile memory within the memory 506, includes a non-transitory computer readable storage medium. In some implementations, the memory 506, or the non-transitory computer readable storage medium of the memory 506, stores the following programs, modules, and data structures, or a subset or superset thereof:
an operating system 514, which includes procedures for handling various basic system services and for performing hardware dependent tasks;
a network communication module 516, which connects the server system 160 to other devices (e.g., various servers in the server system 160, computing device 140, a client device, or other devices) via one or more network interfaces 504 (wired or wireless) and one or more networks 150, such as the Internet, other wide area networks, local area networks, metropolitan area networks, and so on;
a user interface module 518, which enables presentation of information (e.g., a graphical user interface for presenting applications, widgets, websites and web pages thereof, and/or games, audio and/or video content) at a computing device 140 or electronic device 178;
a web browser module 520 for navigating, requesting (e.g., via HTTP), and displaying websites and web pages thereof, including a web interface for logging into a user account associated with a computing device 140 or another electronic device, controlling the computing device or electronic device if associated with the user account, and editing and reviewing settings and data that are associated with the user account;
an operational pipeline 524, including:
   a data intake module 526 for obtaining respective neural signals that are collected by respective implant devices;
   a data selection module 528 for automatically choosing the most relevant and suitable data subsets from a larger data pool (e.g., form the one or more databases 162);
   a data processing module 538 for transforming raw sensor data 576 through various processing steps such as data cleaning, normalization, and feature extraction. In some embodiments, the data processing module 538 generates training data for use by a model training module 532 by preparing the processed data in a suitable format;
   the model training module 532 for receiving the training data and establishing one or more data processing models 568 for processing neural data collected by implant devices 110. In some embodiments, the model training module 532 includes labels 534 for training the data processing models 568. In some embodiments, the model training module 532 includes training datasets 536 for training the data processing models 568;
a web application 540, which may be downloaded and executed by a web browser 426 on a user's computing device 140. In general, a web application 540 has the same functionality as application 440, but provides the flexibility of access from any device at any location with network connectivity, and does not require installation and maintenance. In some embodiments, the web application 540 includes various software modules to perform certain tasks, such as:
   a user interface 542, which provides the user interface for all aspects of the web application 540;
   a signal input module 544, which has the same functionalities as signal input module 444
   a signal processing module 546, which has the same functionalities as signal processing module 446;
   an interpretation module 548, which has the same functionalities as interpretation module 448;
   an output module 550, which has the same functionalities as output module 450; and
   a display generation module 552, which has the same functionalities as display generation module 466;
one or more databases 162 for storing at least data including one or more of:
   device settings 562 including common device settings (e.g., service tier, device model, storage capacity, processing capabilities, communication capabilities, etc.) of the one or more server systems 160, computing devices 140, or other devices;
   user account information 564 for the application 440 and/or the web application 540, such as user names, security questions, account history data, user preferences, and predefined account settings
   application data 566 from the application 540, web application 540, and/or the user applications
   firmware data 567 corresponding to respective firmware versions;
   data processing models 568 (e.g., machine learning models, machine learning algorithms, decoding models, and/or decoding algorithms) for decoding neural signal data into intended user actions. In some embodiments, the data processing models 568 include model parameters 570, weights 572, and metadata 574
   raw sensor data 576 acquired by one or more electrode arrays 208;
   derived data 578 obtained by transforming, processing, or analyzing the raw sensor data 576; and
   analytics data 580, which are data that are collected, processed, and analyzed from the raw sensor data 576 and the derived data 578 to gain insights and identify patterns; and
APIs 590 for receiving API calls from one or more applications (e.g., web browser module 520, user applications 522, and web application 540) and the one or more data processing models 568, translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 506 stores a subset of the modules and data structures identified above. Furthermore, the memory 506 may store additional modules or data structures not described above.

Although FIG. 5 shows a server system 160, FIG. 5 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 160 may be stored or executed on a computing device 140. In some embodiments, the functionality and/or data may be allocated between a computing device 140 and one or more server systems 160. Furthermore, one of skill in the art recognizes that FIG. 5 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

### Brain Computer Interface Systems, Devices, and Methods that Utilize Ultra-wideband (UWB) Communication

Decoding brain activities in the sensorimotor cortex region requires obtaining high spatiotemporal-resolution data at high sampling frequencies and very low noise. For example, electrophysiological data can be collected from a subdural-contained array of electrodes that is located inside a patient's skull, and transmitted outside the patient's skull using an implant device. Some existing solutions are inconvenient to use because they require a physical cable connection from the implant device to a nearby computer for data transfer. Other existing approaches focus on transmitting the data wirelessly, to avoid the inconvenience of using a cable. However, wireless transmission of such data through a human scalp tissue is a challenging problem because the human scalp is made up of a combination of fat, skin and blood vessels, which makes its relative permittivity high compared to that of air. Additional requirements, such as low latency, high bandwidth, low error rates, small footprint, and low power consumption, further exacerbate the complexity of designing such devices.

Ultra-wideband (UWB) communication technology is a suitable candidate for transferring neural data. Its advantages include: (i) high bandwidth; (ii) consumes relatively low power; (iii) has significantly lower latency compared to other wireless technologies such as WiFi, 60 GHz, or BLE; (iv) operates in a wide frequency band between around 3.1 GHz to 10.6 GHz, which has the potential to provide high data rates for medical implant communication; and (v) UWB signals do not significantly diminish when transmitting over human skin and fat.

However, compared to other communication technologies, UWB has a few shortcomings. UWB communication tends to require a larger-sized antenna, which is not practical for the smaller form factor required for medical implant devices. Furthermore, medical implant devices rely on wireless power for operation, which in turn adds stringent shielding requirements to protect biological signals (e.g., neural signals) being captured. A common tool for shielding is a ground plane, which blocks and limits the functionality of any antenna. Furthermore, UWB has relatively low physical layer rate (PHY) (e.g., a theoretical maximum speed at which data can be transmitted) and MAC bitrates at smaller footprint antennas compared to other technologies.

Some embodiments disclose a cranial implant device that provides a technical solution to the aforementioned technical problems. As disclosed, the cranial implant device includes a set of components (e.g., electronic components) enclosed in a hermetically sealed, biocompatible enclosure. In some embodiments, the hermetically sealed, biocompatible enclosure includes a titanium main body and a ceramic lid on top of the RF power and antenna placements. A conductive shielding layer (e.g., shielding component) separates the ceramic lid from the main electronics assembly (e.g., main electronics board). On top of the conductive shielding layer is a ferrite layer (e.g., ferrite component). The antennas (UWB/Bluetooth) are designed to be in capacitive mode. The antenna flex or printed circuit board(s) are attached to the bottom of the ceramic lid. In some embodiments, the ceramic lid has a very low loss and very high electrical permittivity (εᵣ−epsilon) properties. Consequently, most of the capacitive antenna transmission (e.g., desirable antenna radiation) would be radiated in a direction towards the top and out of the implant device toward the wearable device. On the other hand, the inductive mode radiation inside the implant device (e.g., undesirable antenna radiation) would be radiated in a downward direction and be suppressed by the presence of ferrite layer (e.g., ferrite shield) which is lossy at the antenna frequencies. Additionally, the loss of the ferrite layer prevents residual radiation signals that do transmit downward to be attenuated. If the downward radiation is not attenuated, the ground shield can act as a mirror and reflect the radiation signals back to the antenna, which may add de-constructively with the upward radiation and significantly reduce the antenna upward radiation.

As disclosed, in some embodiments, the implant device mitigates UWB technology's lower bandwidth by combining specially crafted hardware and firmware to allow for efficient UWB transmission of data, enabling the implant device to reach higher bandwidths while still maintaining the rest of the benefits of the technology.

As disclosed, in some embodiments, the cranial implant device employs a UWB radio in addition to a side-band radio (e.g., Bluetooth or BLE). The UWB radio allows UWB signals (e.g., raw neural signals) to transmit unidirectionally, while the side-band radio processes configuration and control requests. Together with careful system-level design, the hardware can reach excellent bandwidth for small footprint antennas, while maintaining low latency and power consumption. The firmware (e.g., Verilog) utilizes the UWB radio in a way that pushes data rates that are very close to the PHY rate, via efficient unidirectional transmission in the MAC layer. The firmware also processes the side-radio for control/configuration packets and controls the hardware as needed.

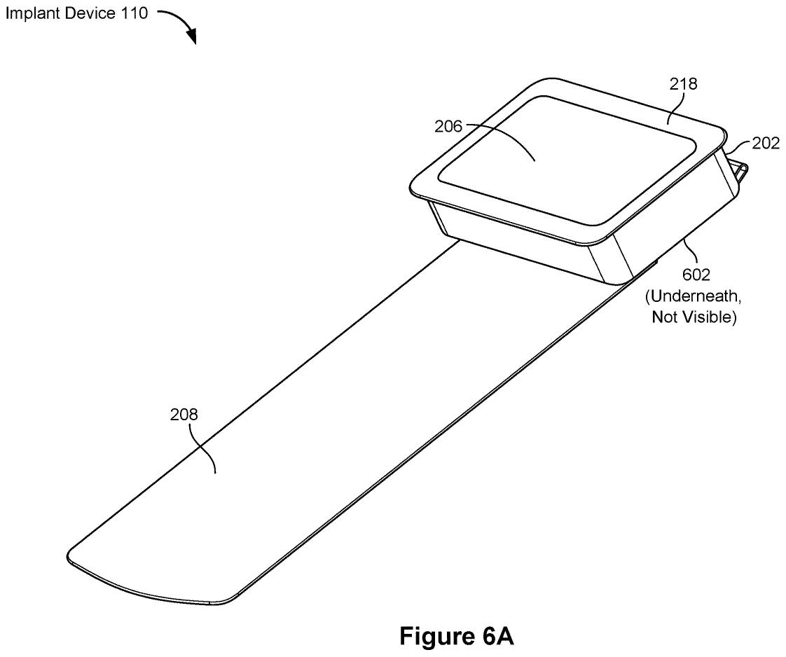

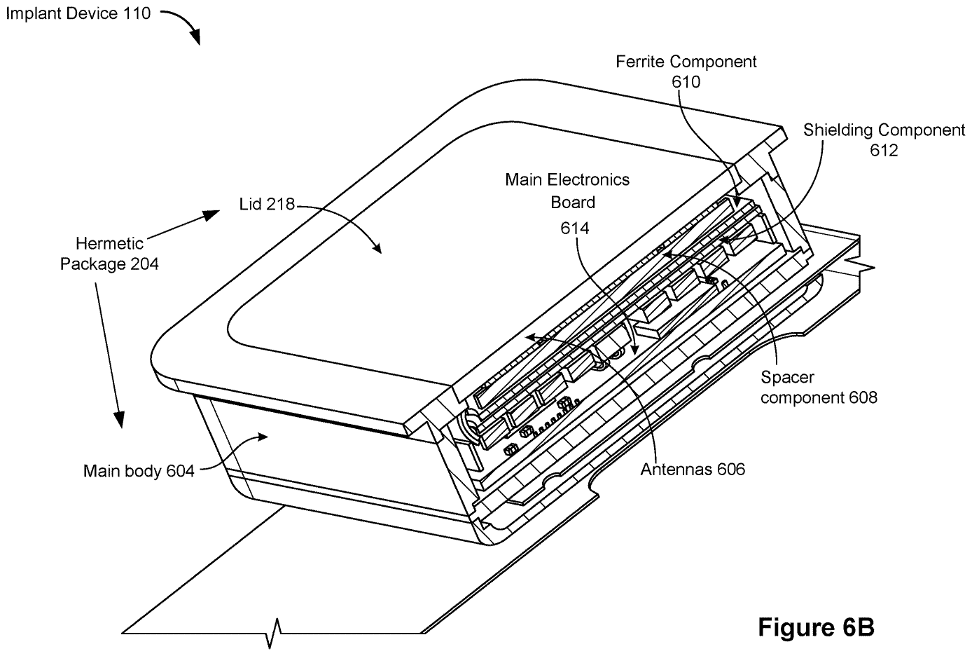

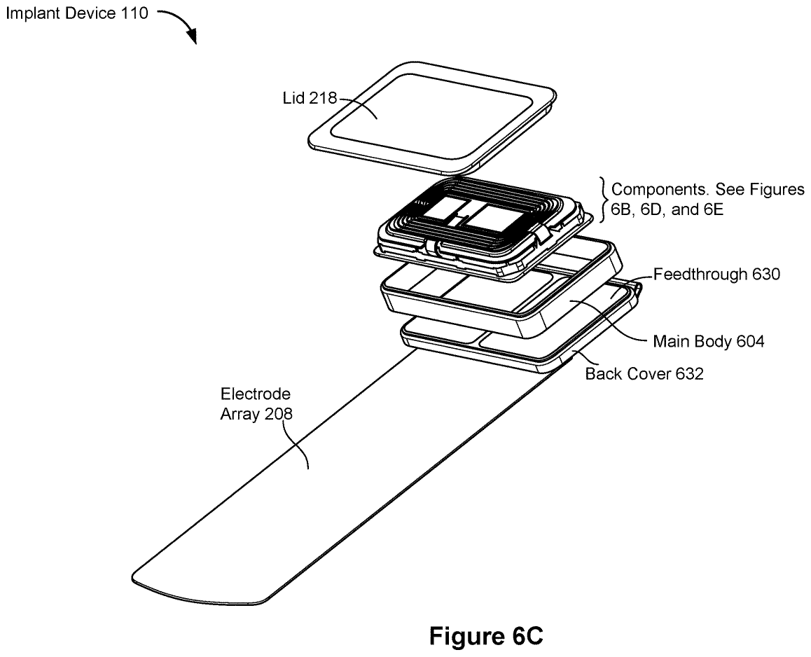

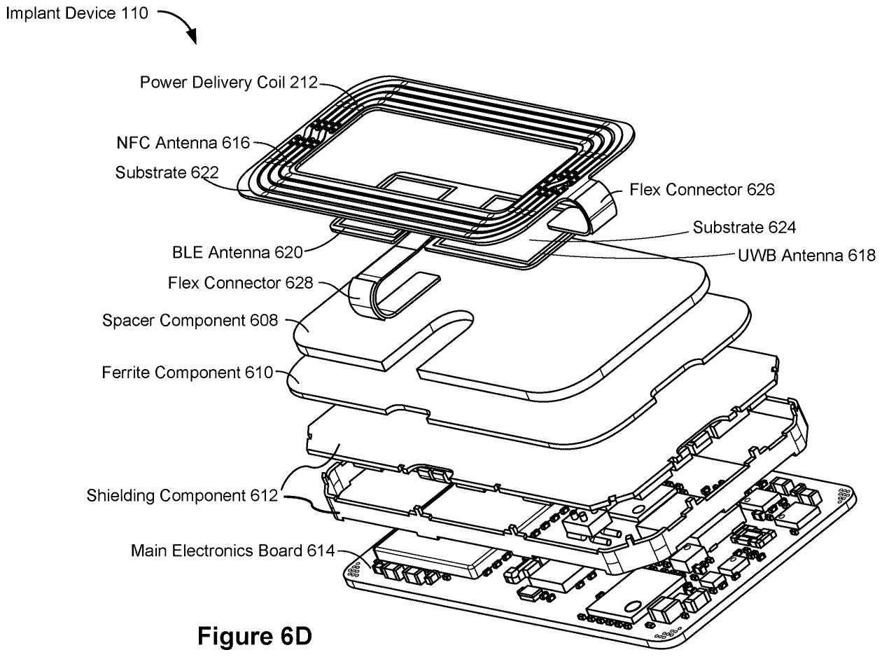

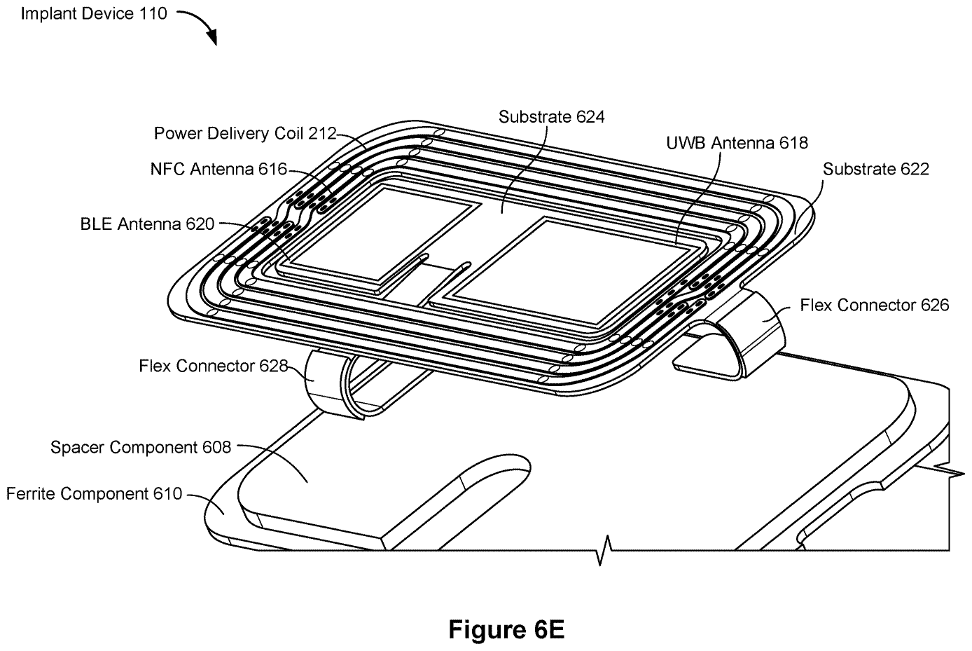

FIGS. 6A to 6E illustrate various views of an implant device 110, in accordance with some embodiments. In accordance with some embodiments, the implant device 110 is configured to be anchored to a skull of a patient (e.g., human subject 102). In some embodiments, the implant device 110 is communicatively and magnetically coupled to a wearable device 130, which is positioned at a scalp of the patient.

Referring to FIG. 6A (and also FIGS. 2A to 2C), in some embodiments, the implant device 110 includes a frame 202, a biocompatible hermetic package 204, and implant electronics 206 (e.g., one or more electronic components) enclosed in the hermetic package 204. As used herein, the hermetic package 204 is also referred to as a hermetically-sealed package or a hermetically sealed enclosure.

The implant device includes an electrode array 208, as discussed with reference to FIGS. 2A to 2C. The electrode array 208 is configured to be positioned on a surface of a brain of the patient. In some embodiments, the electrode array 208 includes bonding pads 602. In some embodiments, the bonding pads 602 are located at a surface of the electrode array 208 that faces the hermetic package 204. In some embodiments, the bonding pads 602 are coupled to the hermetic package 204 via a feedthrough 630 (FIG. 6C) of the hermetic package 204. The hermetic package 204 is configured to receive the neural data of the patient via the bonding pads 602.

In some embodiments, the hermetic package 204 is coupled to bonding pads 602 of a sensing array (e.g., electrode array 208) that is positioned on a surface of a brain of the patient. The hermetic package 204 (e.g., the electronic components within the hermetic package) is configured to receive neural data of the patient via the bonding pads 602 and configured to transmit the neural data from the implant device 110 to the wearable device 130 In some embodiments, the implant device 110 is configured to transmit raw, unprocessed neural data to the wearable device 130 without processing the data.

FIGS. 6A, 6B, and 6C show that in some embodiments, the hermetic package 204 includes a lid 218, a main body 604, and a back cover 632. The lid 218 is the cover 218 shown in FIG. 2C. The terms “lid” and “cover” are used interchangeably throughout this disclosure. The lid 218, the main body 604, and the back cover 632 are made of biocompatible materials.

In some embodiments, the lid 218 comprises a material with a high dielectric constant (e.g., high relative permittivity). In some embodiments, the implant device 110 is a battery-less device (i.e., it does not include a battery) and receives its power wirelessly from the wearable device 110. In some embodiments, the high relative permittivity value of the lid 218 facilitates the receiving of power signals from the wearable device 130 via inductive coupling or capacitive coupling.

In some embodiments, the lid 218 comprises a ceramic material. Example ceramic materials can include a zirconium-based material such as zirconia (or zirconium dioxide) or yttria-stabilized zirconia (YSZ), alumina, hydroxyapatite, and/or bioactive glasses.

In some embodiments, the main body 604 comprises a titanium material.

In some embodiments, the hermetic package 204 is formed by joining the lid 218 to the main body 604 via a joining process such as welding, bonding, brazing, or using an adhesive (e.g., epoxy, a ceramic-based adhesive, or a silicone-based adhesive) that is formulated to bond titanium and ceramic. For example, in some embodiments, the lid 218 can be joined to the main body 604 via a welding process such as direct welding, friction stir welding, and/or ultrasonic welding. In some embodiments, the lid 218 can be joined to the main body 604 via a bonding process such as electric field bonding and/or diffusion bonding. In some embodiments, the lid 218 can be joined to the main body 604 via a brazing process using a filler metal such as gold. As an example where the lid 218 comprises a zirconium-based ceramic material and the main body 604 is a titanium material, the gold filler metal joins the lid 218 to the main body 604 and forms titanium oxide or copper-titanium oxide on the zirconia side.

In some embodiments, the hermetic package 204 is formed by joining the lid 218 to the main body 604 via a high temperature joining process that occurs at a temperature that is at least 700° C., 800° C., 900° C., or 1000° C. As an example, the lid 218 comprises a ceramic material, the main body 604 comprises a titanium material, and the ceramic lid is joined to the titanium main body via a welding or brazing process that is performed at around 1000° C.

In accordance with some embodiments, the lid 218 is connected to the main body 604 via a high-temperature joining process that occurs at around 1000° C. Consequently, the antennas 606 are not directly printed on the ceramic lid 218 because the high-temperature joining process will cause the antennas to be destroyed. Consequently, in some embodiments, the antennas are printed on one or more substrates (e.g., substrate 622 and substrate 624) that are positioned adjacent to the ceramic lid 218, and described below.

FIG. 6B shows a cross-sectional view of the implant device 110, in accordance with some embodiments. The implant device 110 includes a set of (e.g., one or more) components enclosed in (e.g., within) the hermetic package 204. FIG. 6C shows an exploded assembly view of the components enclosed within the hermetic package 204, in accordance with some embodiments. In some embodiments, the components include one or more of: one or more antennas 606 (e.g., communication antenna 214), spacer component 608, a ferrite component 610, and shielding component 612, and/or a main electronics board 614.

In some embodiments, the one or more antennas 606 are the same as communication antenna depicted in FIG. 2C. In some embodiments, the one or more antennas 606 are configured to enable communication with the wearable device 130. In some embodiments, the one or more antennas 606 include a near-field communication (NFC) antenna 616 (e.g., NFC communication coil) that enables short-range wireless communication with the wearable device 130. In some embodiments, the one or more antennas 606 include an ultra-wideband (UWB) antenna 618 (e.g., UWB coil) that enables very low energy, short-range, wireless, high-bandwidth communication over a large portion of the radio spectrum. In some embodiments, the UWB antenna 618 is configured to operate in capacitive mode. In some embodiments, the one or more antennas 606 include a Bluetooth Light Energy (BLE) antenna 620 (e.g., Bluetooth antenna or Bluetooth coil) that enables short-range wireless communication. In some embodiments, the BLE antenna 620 is configured to operate in capacitive mode.

FIGS. 6D and 6E show an example arrangement of the components within the hermetic package 204, in accordance with some embodiments. For example, in some embodiments, the components are arranged as multiple layers in a stack within the hermetic package 204. The first layer in the stack, immediately adjacent to the lid 218, includes a power delivery coil 212 and the one or more antennas 606. In some embodiments, the first layer does not physically contact the lid 218. The second layer in the stack (e.g., immediately adjacent to the first layer and away from the lid 218) comprises the spacer component 608. The third layer in the stack (e.g., immediately adjacent to the second layer) comprises the ferrite component 610. The fourth layer in the stack (e.g., immediately adjacent to the third layer) comprises the shielding component 612. The fifth layer in the stack (e.g., immediately adjacent to the fourth layer) comprises the main electronics board 614.

Referring now to FIGS. 6C, 6D, and 6E, in some embodiments, the components include power delivery coil 212, which is positioned on a substrate 622. The power delivery coil 212 is configured to deliver electrical power from the wearable device 130 to the implant device 110. In some embodiments, the NFC antenna 616 is positioned on the same substrate 622 as the power delivery coil 212. The substrate 622 is coupled to the main electronics board 614 via a flexible (e.g., flex) connector 626. In some embodiments, the NFC antenna 616 and the power delivery coil 212 are implemented as a common conductive structure. In other embodiments, the NFC antenna 616 and the power delivery coil 212 are separate conductive structures. In either arrangement, the NFC channel 740 can provide both wireless power reception and low-level communication for initialization, verification, or recovery of the implant device 110.

In some embodiments, the substrate 622 is a printed circuit board (PCB). In some embodiments, the power delivery coil 212 and/or the NFC antenna 616 are printed on the PCB. In some embodiments, the substrate 622 comprises a flexible PCB, such as a polyimide PCB, a liquid crystal polymer (LCP) PCB, a polyester (PET) PCB, a polyethylene naphthalate (PEN) PCB, a polytetrafluoroethylene (PTFE) PCB, and/or an aramid PCB. In some embodiments, the substrate 622 comprises a rigid PCB such as rigid FR-4. In some embodiments, the choice of the PCB is driven by its electrical qualities.

In some embodiments, the components include UWB antenna 618, which is positioned on a substrate 624. The UWB antenna 618 is configured to transmit neural data of the patient from the implant device 110 to the wearable device 130 (e.g., to a complementary UWB receiving channel of the wearable device 130). In accordance with some embodiments, the implant device 110 transmits raw, unprocessed neural data via the UWB antenna 618 to the wearable device 130 without performing any processing. The UWB antenna 618 is configured to operate in a transmit-only mode, where the UWB antenna 618 is configured to transfer data (e.g., raw, unprocessed neural data) unidirectionally to the wearable device 130 without receiving any data from the wearable device 130. Advantageously, operating the UWB antenna 618 (and the UWB radio module 706) in the transmit-only mode enables the entire capacity of the UWB channel to be used for sending data, which enables more data to be sent and also simplifies the communication process.

In some embodiments, the components include BLE antenna 620, which is positioned on the same substrate 624 as the UWB antenna 618. In some embodiments, the substrate 624 is coupled to the main electronics board 614 via a flexible (e.g., flex) connector 628.

In some embodiments, the substrate 624 is a printed circuit board (PCB). For example, in some embodiments, the UWB antenna 618 and/or the BLE antenna 620 are printed on the PCB. In some embodiments, the substrate 624 comprises a flexible PCB, such as a polyimide PCB, an LCP PCB, a PET PCB, a PEN PCB, a PTFE PCB, and/or an aramid PCB. In some embodiments, the substrate 624 comprises a rigid PCB such as rigid FR-4. In some embodiments, the choice of the PCB is driven by its electrical qualities.

As depicted in FIG. 6D, in some embodiments, the substrate 622 and the substrate 624 are separate and distinct substrates. In some embodiments, both the substrate 622 and the substrate 624 are flexible PCBs. In some embodiments, both the substrate 622 and the substrate 624 are rigid PCBs. In some embodiments, one of the substrates comprises a rigid PCB while the other one of the substrates comprises a flexible PCB. In some embodiments, the substrate 622 and the substrate 624 comprise the same material(s). For example, both the substrate 622 and the substrate 624 are both LCP PCBs. In some embodiments, the substrate 622 and the substrate 624 comprise different materials. For example, the substrate 622 comprises a polyimide PCB and the substrate 624 comprises an LCP PCB. As another example, in some embodiments, the substrate 622 comprises an LCP PCB and the substrate 624 comprises a polyimide PCB.

FIG. 6E shows that in some embodiments, the substrate 622 (that includes the power delivery coil 212 and the NFC antenna 616) and the substrate 624 (that includes the UWB antenna 618 and the BLE antenna 620) are configured to be nested together to form the first layer, of the multiple layers, of the stack within the hermetic package 204. In this arrangement, the substrate 622 with the power delivery coil 212 and the NFC antenna 616 surrounds the substrate 624, the UWB antenna 618, and the BLE antenna 620.

With continued reference to FIGS. 6B, 6C, 6D, and 6E, in some embodiments, the components include spacer component 608. In some embodiments, the spacer component 608 comprises a foam material. For example, in some embodiments, the spacer component 608 comprises a polyurethane foam. In some embodiments, the spacer component 608 comprises a fluoropolymer-based composite material. In some embodiments, the spacer component 608 comprises an ultra-low density polymeric foam. In some embodiments, the spacer component 608 comprises an expanded polytetrafluoroethylene material. In some embodiments, the spacer component 608 comprises a silica- or polymer-based aerogel material.

In some embodiments, the spacer component 608 has a dielectric permittivity value close to one. For example, in some embodiments, the spacer component 608 has low dielectric permittivity, close to that of air (around 1.0), making it suitable for applications requiring low dielectric interference. In some embodiments, the spacer component 608 has low radiofrequency (RF) loss in the UWB range, the Bluetooth frequency range, and/or the NFC frequency range. In some embodiments, the spacer component 608 maintains a separation between the one or more antennas 606 and the ferrite component 610 such that the ferrite component 610 does not excessively load the one or more antennas 606. Because the spacer component 608 can have a dielectric permittivity value close to that of air and low RF loss over the UWB range, the Bluetooth frequency range, and/or the NFC frequency range, the spacer component 608 can reduce dielectric interference while preserving desired antenna characteristics. In some embodiments, the spacer component 608 also provides mechanical stability to maintain the intended spacing and alignment of the one or more antennas 606 and the ferrite component 610 under handling, vacuum packaging, and/or magnetic-field exposure, thereby reducing performance variation caused by movement of the internal stack.

In some embodiments, the lid 218, the spacer component 608, the ferrite component 610, and the shielding component 612 cooperate to preferentially direct signal propagation toward the lid 218 and away from the main electronics board 614. For example, in some embodiments, the materials and dimensions for the lid 218 and the spacer component 608 are selected such that signal propagation is preferentially directed from the spacer component 608 toward the lid 218. For example, in some embodiments, the lid 218 has a high dielectric constant value (e.g., high relative permittivity, εᵣ) that is greater than an effective permittivity of the spacer component, such that the upward propagation path toward the scalp is favored over the downward propagation path toward the shield and electronics. In some embodiments, the lid 218 comprises a material that is selected such that an “effective” permittivity of the lid (calculated by multiplying a thickness of the lid 218 by the square root of the relative permittivity of the lid material) is greater than an “effective” permittivity of the spacer component 608 (calculated by multiplying a thickness of the spacer layer by the square root of the permittivity of the spacer layer), to ensure that the direction of signal propagation is from the spacer component 608 to the lid 218. In some embodiments, the lid 218 comprises a ceramic lid with a very low loss and very high electrical permittivity, which facilitates capacitive antenna transmission (e.g., desirable antenna radiation) in the desired direction, which is towards the lid 218, out of the implant device 110, and toward the wearable device 130. Because the the lid 218 can have a relative permittivity closer to that of the scalp than to that of air, reflection at the lid-scalp interface can also be reduced, thereby improving reliability of the direct wireless link without requiring a larger antenna or a larger implant package. In some embodiments, the ceramic lid 218 assists operation of the UWB antenna 618 such that the UWB antenna 618 can be made smaller while maintaining a communication link suitable for high-bandwidth neural-data transfer. This can allow the implant device 110 to accommodate the power delivery coil 212, the NFC antenna 616, the UWB antenna 618, and the BLE antenna 620 within the limited area of the hermetic package 204 while preserving a form factor suitable for cranial implantation.

In some embodiments, the components include ferrite component 610 (e.g., ferrite layer, ferrite core, or ferrite shield) positioned immediately adjacent to the spacer component 608. The ferrite core comprises a magnetic material and is configured to reduce electromagnetic interference (EMI) and radio frequency interference (RFI) by absorbing unwanted electromagnetic energy. In accordance with some embodiments, the ferrite component 610 suppresses high-frequency noise over a broad frequency range and prevents unwanted (e.g., high-frequency noise) electromagnetic energy from reflecting back to the one or more antennas 606. In particular, the inductive mode radiation inside the implant device 110 (e.g., undesirable antenna radiation) would be radiated in a downward direction and be suppressed by the presence of ferrite component 610 (e.g., ferrite shield) which is lossy at the antenna frequencies. Additionally, the loss of the ferrite component 610 prevents residual radiation signals that do transmit downward to be attenuated. If the downward radiation is not attenuated, the ground shield can act as a mirror and reflect the radiation signals back to the antenna, which may add de-constructively with the upward radiation and significantly reduce the antenna upward radiation.

In some embodiments, the components include shielding component 612 (e.g., shielding layer) that is positioned immediately adjacent to the ferrite component 610. The shielding component 612 comprises an electrically conductive material to minimize electromagnetic emissions from the implant device 110 and to protect the implant device 110 from external electromagnetic interference (EMI). As disclosed, the shielding component 612 separates the ceramic lid 218 from the main electronics assembly (e.g., main electronics board 614). In some embodiments, the shielding component 612 reduces electromagnetic interference (EMI) emissions, improves device performance, and ensures that the implant device 110 meets compliance standards stipulated by the Federal Communications Commission (FCC).

In some embodiments, the components include main electronics board 614. The main electronics board 614 includes processing circuitry, communication circuitry, and power circuitry. In some embodiments, the various circuitries are implemented as a multi-channel application-specific integrated circuit (ASIC) chip (e.g., ASIC 702) that enables custom programming of specific tasks. In some embodiments, the ASIC chip is implemented as a system-on-chip (SOC). In some embodiments, the ASIC chip and includes one or more microprocessors and one or more memory blocks such as ROM, RAM, EEPROM, flash memory, or other building blocks. In some embodiments, the ASIC chip includes an analog-to-digital converter (ADC) with a first-in, first-out (FIFO) buffer that is used to efficiently store and manage the data streams generated by the ADC.

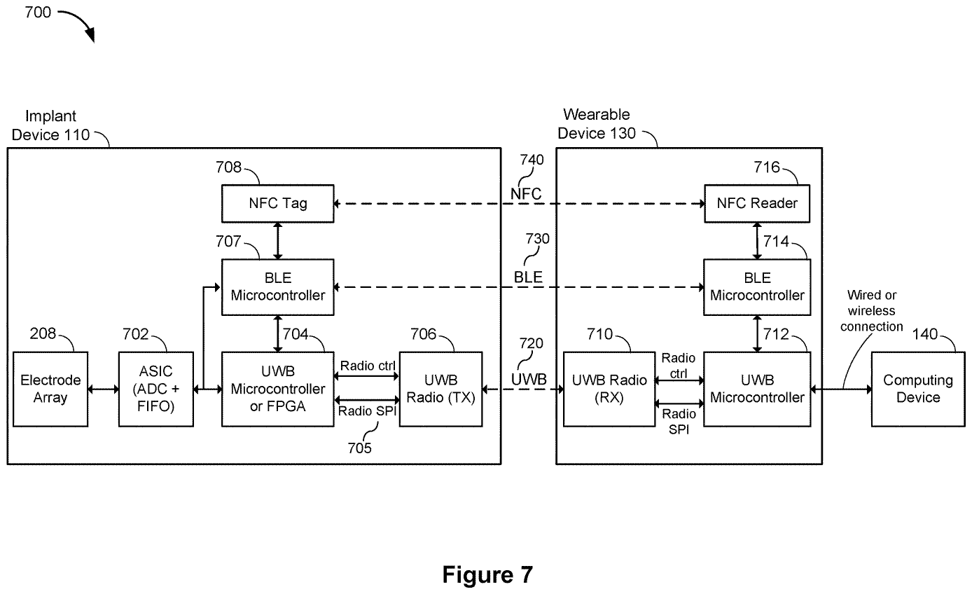

FIG. 7 is a block diagram 700 illustrating data communication between an implant device 110, a wearable device 130, and a computing device 140, in accordance with some embodiments. In some embodiments, the implant device 110, the wearable device 130, and the computing device 140 are part of a BCI system. Please also refer to FIG. 2D which illustrates an example data path, control path, and power path of the implant device 110, and FIG. 3B which illustrates an example data path, control path, and power path of the wearable device 130.

The implant device 110 includes an electrode array 208 that includes sensor electrodes that are configured to collect neural data from the brain of a patient.

In some embodiments, the implant device 110 includes an ASIC 702, which can be implemented as at least part of main electronics board 614. In some embodiments, ASIC 702 includes an analog-to-digital converter (ADC) (e.g., analog neural signal to digital converter module 240 in FIG. 2D) that is configured to convert the neural signals (e.g., electrical signals) from analog form to digital form (e.g., digital signals 241). In some embodiments, ASIC 702 includes a first-in, first-out (FIFO) buffer configured to store and manage the data streams generated by the ADC. In some embodiments, the ASIC 702 includes custom hardware that is configured to digitally process data samples and store the data samples in the FIFO buffer.

In some embodiments, the implant device 110 includes a UWB microcontroller 704. In some embodiments, the UWB microcontroller 704 includes one or more Field Programmable Gate Arrays (FPGA), reconfigurable hardware logic blocks, or other programmable circuitry configured for data-handling tasks associated with neural data transmission. In some embodiments, the UWB microcontroller 704 is configured to implement and/or execute custom firmware that pulls information from the FIFO buffer of the ASIC 702 and pushes the information to a UWB radio module 706 of the implant device 110. A serial peripheral interface (SPI) (e.g., depicted as Radio SPI 705 in FIG. 7) can be used for communication between the UWB microcontroller 704 and the UWB radio module 706, thereby allowing the UWB microcontroller 704 to send commands and receive data from the UWB radio module 706. In some embodiments, the UWB radio module 706 uses short-range, high-frequency radio waves across a broad spectrum (e.g., about 3.1 GHz to 10.6 GHz) to enable high-speed data transmission from the implant device 110 to a complementary UWB radio module 710 of the wearable device 130.

With continued reference to FIG. 7, in some embodiments, the wearable device 130 includes a UWB controller 712 that is communicatively connected to the complementary UWB radio module 710. In some embodiments, the complementary UWB radio module 710 and the UWB controller 712 form at least part of the neural data receiver module 332 illustrated in FIG. 3B. The UWB controller 712 can provide the received neural data to the computing device 140 using a wired or wireless connection. In some embodiments, the neural data transmitted from the implant device 110 to the wearable device 130, and from the wearable device 130 to the computing device 140, comprises raw unprocessed data. In some embodiments, the neural data that is transmitted from the implant device 110 to the wearable device 130, and from the wearable device 130 to the computing device 140, consists only of raw unprocessed data. In some embodiments, the implant device 110 transmits raw, unprocessed neural data over the UWB channel 720 to the wearable device 130 without performing substantial onboard interpretation of the neural data. Offloading the raw neural data to the wearable device 130 and/or the computing device 140 can preserve information content for downstream decoding while reducing processing burden within the implant device 110. This division of functionality can be particularly beneficial in a battery-less cranial implant that is subject to strict size, power, and thermal constraints.

In some embodiments, the direction of UWB signal transmission is unidirectional, such that neural data is transmitted from the UWB radio module 706 to the complementary UWB radio module 710 without UWB reception at the implant device 110. In some embodiments, the UWB radio module 706 is configured to operate in a transmit-only mode. The UWB microcontroller/FPGA 704 can be configured to implement and/or execute custom firmware that optimizes the UWB radio module 706 for bandwidth and latency by implementing a medium access control (MAC) layer adapted for unidirectional traffic. Stated another way, in some embodiments, the UWB radio module 706 is configured to operate in a transmit-only mode, where it transmits short-range, wireless neural data unidirectionally to the wearable device 130, without any receiving functionality. In some embodiments, restricting the UWB path to outbound transmission enables a greater portion of the UWB channel capacity to be used for neural-data transfer and can reduce implant-side communication overhead. In other embodiments, the direction of UWB signal transmission is bidirectional, such that the complementary UWB radio module 710 is also able to transmit data to the UWB radio module 706.

With continued reference to FIG. 7, in some embodiments, the implant device 110 includes a BLE microcontroller 707 that is communicatively connected to the UWB microcontroller 704 and the UWB radio module 706. The BLE microcontroller 707 can be configured to implement and/or execute custom firmware that allows control of the ADC, the FIFO buffer, and the UWB radio module 706.

In some embodiments, the BLE microcontroller 707 is configured to receive and transmit short-range, wireless side band data to a complementary BLE microcontroller 714 of the wearable device 130 through BLE channel 730. The complementary BLE microcontroller 714 can receive the side band data and provide corresponding control, status, or other information within the wearable device 130. In some embodiments, the side band data includes data distinct from neural data, which is transmitted through the UWB channel 720.

In some embodiments, the side band data includes feedback data associated with operation of the UWB channel 720, operation of the implant device 110, and/or operation of the wearable device 130. For example, the feedback data can include acknowledgement data, negative acknowledgement data, packet receipt status, packet loss indications, retransmission requests, buffer occupancy information, queue status information, latency information, timing information, synchronization information, link-quality information, signal-strength information, bit-error information, packet-error information, throughput information, congestion information, power status information, fault information, diagnostic information, and/or other information indicating whether neural-data transfer is proceeding as intended. In some embodiments, the acknowledgement data includes one or more signals or data fields indicating whether one or more packets of neural data were successfully received by the wearable device 130. For example, the acknowledgement data can include an acknowledgement (ACK) message confirming successful receipt of a packet, a negative acknowledgement (NACK) message indicating that a packet was not received correctly or was lost, a selective acknowledgement identifying a subset of packets successfully received, a missing-packet indication, a duplicate-packet indication, and/or a retransmission request.

In some embodiments, the side band data can include control data, such as commands, settings, or other information used to configure, coordinate, or modify operation of the implant device, the wearable device, and/or communication between the implant device and the wearable device. For example, the control data can include commands to start, stop, pause, or resume neural-data streaming; commands to initialize, boot, reset, or place one or more components into a low-power mode; commands to enable or disable one or more sensing channels, antennas, or radios; commands specifying a sampling mode, a channel-selection mode, a data rate, a packet format, a packet size, or an error-handling setting; and/or commands associated with pairing, authentication, calibration, diagnostics, firmware update, or recovery. In some embodiments, the control data is distinct from the neural data carried over the UWB radio module and the complementary UWB radio module.

In some embodiments, the side band data can include status data such as operating-state information associated with the implant device and/or the wearable device. For example, the status data can include boot status, initialization status, readiness status, radio status, streaming status, memory status, temperature status, power availability status, fault status, or recovery status. In some embodiments, the side band data carried over the BLE channel 730 includes one or more of the feedback data, acknowledgement data, control data, configuration data, and status data described herein, while neural data is carried over the UWB channel 720.

In some embodiments, the communication architecture of the implant device 110 assigns different communication functions to different wireless channels. Referring to FIG. 7, in some embodiments, the communication architecture can include UWB channel 720, BLE channel 730, and NFC channel 740. The NFC channel 740 can be used for initial power transfer and low-level communication; the BLE channel 730 is used for control and feedback communication; and the UWB channel 720 is used for high-bandwidth neural data transfer. In some embodiments, the neural data transfer over the UWB channel 720 is unidirectional from the implant device 110 to the wearable device 130, even though other embodiments can employ bidirectional UWB communication from the implant device 110 to the wearable device 130 and from the wearable device 130 to the implant device 110. In some embodiments, by restricting the UWB path to outbound neural-data transmission, a greater portion of the UWB channel capacity can be used for neural-data transfer, thereby reducing communication overhead and lowering implant-side power consumption. In some embodiments, the BLE channel 730 carries side-band communication including configuration data, feedback data, status data, ACK data, negative NACK data, or other control information, while the UWB channel 720 carries neural data. In some embodiments, the initialization process is handled by NFC communication, via NFC tag 708, using NFC channel 740.

In some embodiments, the NFC channel 740 is used before the BLE channel 730 and the UWB channel 720 are fully initialized. For example, the NFC reader 716 of the wearable device 130 can initially apply an NFC signal that powers at least part of the implant device 110 and establishes initial communication with the implant device 110 through the NFC tag 708. In some embodiments, before booting (e.g., initializing) one or more higher-level communication components, such as the BLE microcontroller 707 and/or the UWB microcontroller 704, the implant device 110 and the wearable device 130 communicate over the NFC channel 740 to verify that the wireless power-delivery link is sufficiently stable and robust for full system operation.

In some embodiments, the NFC channel 740 is used to perform a power-on self-test (e.g., verification process). For example, before the implant device 110 enables the BLE microcontroller 707, the UWB microcontroller 704, or other system loads, the implant device 110 can receive commands over the NFC channel to selectively power one or more components, enable an artificial load, and/or perform a stress-test, to evaluate whether the NFC-based power-delivery link has sufficient coupling and available power to support continued operation. In some embodiments, the wearable device 130 and the implant device 110 perform a handshake over the NFC channel 740 and use the NFC channel 740 to stress-test the power-delivery link before enabling additional implant subsystems. Once the NFC-based link is determined to satisfy one or more stability or power thresholds, the implant device 110 can receive additional commands over the NFC channel 740 to boot up the BLE microcontroller 707, the UWB microcontroller 704, and/or other circuitry.

In some embodiments, the NFC channel 740 remains available after the initial boot up, to function as a lower-level recovery interface. For example, if the BLE channel 730 becomes unavailable or if higher-level firmware becomes corrupted, the implant device 110 can receive a firmware update through the NFC channel 740 alone. Because the NFC channel 740 can operate while relatively few implant subsystems are active, the NFC channel 740 can provide a recovery path for restoring communication capability, updating executable code, reconfiguring device settings, or otherwise recovering operation of the implant device 110.

It will be apparent to one skilled in the art that although several embodiments are described with respect to UWB communication, the high-bandwidth outbound data link is not limited to UWB. In some embodiments, the implant device 110 can additionally or alternatively use another directional, short-range, high-bandwidth wireless communication protocol in place of, or in addition to, the UWB protocol, while still using a lower-bandwidth side channel and/or an NFC-based initialization channel for control, feedback, initialization, recovery, or power-verification operations.

In some embodiments, the implant device 110 includes an NFC tag 708. The NFC tag 708 includes the NFC antenna 616 and a microchip that stores data and processes commands. The NFC tag 708 is a tertiary radio channel that enables pairing with an NFC reader 716 of the wearable device at the initial interaction. In some embodiments, the NFC tag 708 is configured to establish a secure handshake with the wearable device 130. In some embodiments, the secure handshake comprises a secure BLE handshake. That is to say, in some embodiments, the NFC tag 708 is configured to establish a Bluetooth connection (e.g., a secure BLE handshake) between the BLE microcontroller 707 of the implant device 110 and the complementary BLE microcontroller 714 of the wearable device 130, where the Bluetooth connection is used for subsequent side band communication between the implant device 110 and the wearable device 130. In some embodiments, the NFC tag 708 is configured to receive power wirelessly from the NFC reader 716. In some embodiments, the implant device 110 stores power that it receives from the NFC reader 716 via power delivery coil 212 (e.g., using electromagnetic induction).

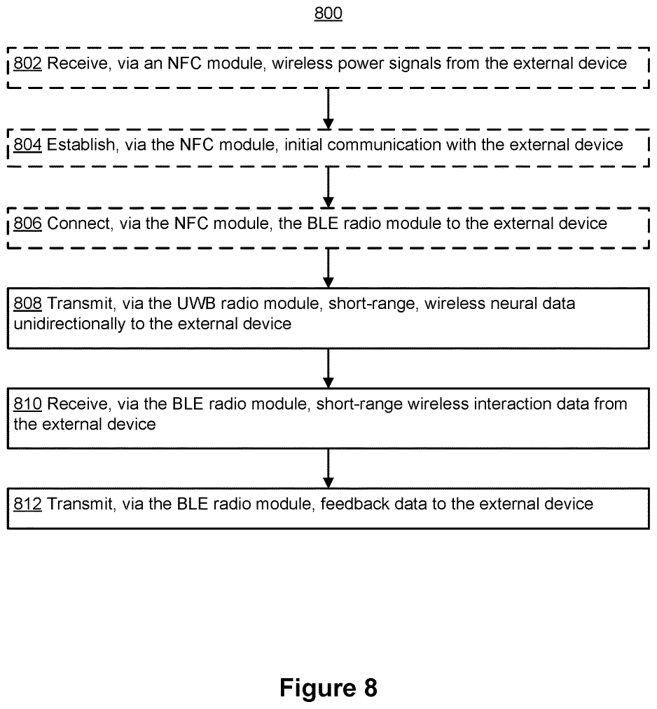

FIG. 8 is a flowchart of an example process for neural data communication, in accordance with some embodiments.

The method 800 is performed at a BCI system that includes a cranial implant device (e.g., implant device 110) and an external device (e.g., wearable device 130). In some embodiments, the cranial implant device includes a UWB radio module (e.g., UWB radio module 706). In some embodiments, the cranial implant device includes a Bluetooth Low Energy (BLE) radio module (e.g., BLE microcontroller 707). In some embodiments, the cranial implant device includes an NFC module (e.g., NFC tag 708). In some embodiments, the external device includes a UWB radio module (e.g., complementary UWB radio module 710). In some embodiments, the external device includes a BLE radio module (e.g., BLE microcontroller 714). In some embodiments, the external device includes an NFC module (e.g., NFC reader 716). In some embodiments, the operations shown in FIGS. 1A-1D, 2A to 2D, 3A, 3B, 6A-6E, and 7 correspond to instructions stored in the memory block of an ASIC of the cranial implant device. Some operations in the method 800 can be combined with other operations described in method 900 and/or method 1000, and/or the order of some operations may be changed.

In some embodiments, the cranial implant device receives (802), via an NFC module (e.g., NFC tag 708), wireless power signals from the external device to operate the cranial implant device. In some embodiments, the cranial implant device receives the wireless power signals from an NFC reader 716 of the external device.

In some embodiments, the cranial implant device establishes (804), via the NFC module, initial communication with the external device (e.g., with an NFC reader 716 of the external device).

In some embodiments, the cranial implant device connects (806), via the NFC module, the BLE radio module to the external device.

In some embodiments, the cranial implant device transmits (808), via the UWB radio module, short-range, wireless neural data unidirectionally to the external device.

In some embodiments, the cranial implant device receives (810), via the BLE radio module, short-range wireless interaction data from the external device. In some embodiments, the interaction data can include feedback data associated with operation of the UWB channel 720, operation of the implant device 110, and/or operation of the wearable device 130; control data; and/or status data, as described with reference to FIG. 7.

In some embodiments, the cranial implant device transmits (812), via the BLE radio module, feedback data to the external device. For example, in some embodiments, the side band data includes feedback data associated with operation of the UWB channel 720 and/or operation of the cranial implant device 110. For example, the feedback data can include acknowledgement data, negative acknowledgement data, packet receipt status, packet loss indications, retransmission requests, buffer occupancy information, queue status information, latency information, timing information, synchronization information, link-quality information, signal-strength information, bit-error information, packet-error information, throughput information, congestion information, power status information, fault information, diagnostic information, and/or other information indicating whether neural-data transfer is proceeding as intended.

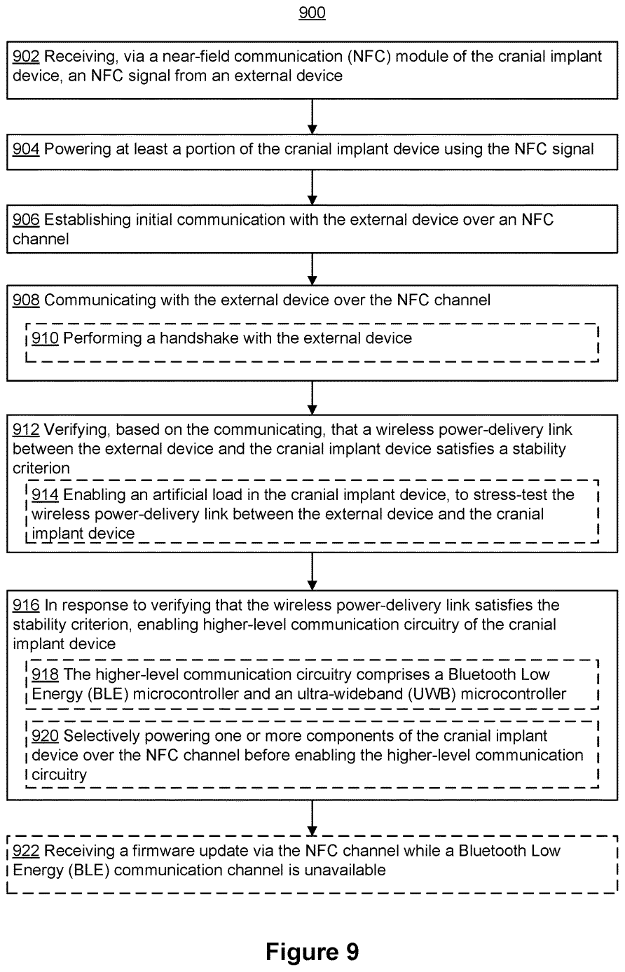

FIG. 9 is a flowchart of an example process for booting (e.g., initializing) a cranial implant device, in accordance with some embodiments. The method 900 is performed at a BCI system that includes a cranial implant device (e.g., implant device 110) and an external device (e.g., wearable device 130). In some embodiments, the cranial implant device includes a UWB radio module (e.g., UWB radio module 706). In some embodiments, the cranial implant device includes a Bluetooth Low Energy (BLE) radio module (e.g., BLE microcontroller 707). In some embodiments, the cranial implant device includes an NFC module (e.g., NFC tag 708). In some embodiments, the external device includes a UWB radio module (e.g., complementary UWB radio module 710). In some embodiments, the external device includes a BLE radio module (e.g., BLE microcontroller 714). In some embodiments, the external device includes an NFC module (e.g., NFC reader 716). In some embodiments, the operations shown in FIGS. 1A-1D, 2A to 2D, 3A, 3B, 6A-6E, and 7 correspond to instructions stored in the memory block of an ASIC of the cranial implant device. Some operations in the method 900 can be combined with other operations described in method 800 and/or method 1000, and/or the order of some operations may be changed.

The method 900 includes receiving (902), via a near-field communication (NFC) module of the cranial implant device, an NFC signal from an external device.

The method includes powering (904) at least a portion of the cranial implant device using the NFC signal.

The method includes establishing (906) initial communication with the external device over an NFC channel.

The method includes communicating (908) with the external device over the NFC channel.

In some embodiments, communicating with the external device over the NFC channel includes performing (910) a handshake with the external device. In some embodiments, the handshake process includes exchanging initialization information between the cranial implant device 110 and the wearable device 130 over the NFC channel 740 before higher-level communication circuitry is enabled. In some embodiments, the handshake is used to confirm that communication over the NFC channel has been established and that the wireless power-delivery link is sufficiently stable for continued initialization. In some embodiments, the handshake further includes a secure pairing procedure used to establish a subsequent BLE connection between the cranial implant device and the wearable device. In some embodiments, the handshake includes specific identifiers, cryptographic keys, challenge-response values, or timing negotiations.

The method includes verifying (912), based on the communicating, that a wireless power-delivery link between the external device and the cranial implant device satisfies a stability criterion.

In some embodiments, verifying that the wireless power-delivery link satisfies the stability criterion includes enabling (914) an artificial load in the cranial implant device, to stress-test the wireless power-delivery link between the external device and the cranial implant device.

The method includes, in response to verifying that the wireless power-delivery link satisfies the stability criterion, enabling (916) higher-level communication circuitry of the cranial implant device.

In some embodiments, the stability criterion for wireless power-delivery link includes whether the wireless power-delivery link is sufficiently stable and robust to support continued operation of the implant device 110. For example, the stability criterion can include whether coupling between the external device and the implant device 110 is above a threshold, whether available received power is above a threshold, whether the link can sustain operation while an artificial load is enabled, whether the link remains stable for at least a threshold period of time, whether a measured voltage or current is within an acceptable range, whether a power margin is sufficient to support boot of one or more additional subsystems, whether communication over the NFC channel remains reliable during a stress test, and/or whether one or more fault conditions are absent while the wireless power-delivery link is active. In some embodiments, the stability criterion is satisfied when the wireless power-delivery link can provide sufficient power to operate the implant device 110 in an initialization mode and to subsequently enable one or more higher-level communication components, such as a BLE microcontroller 707 and/or a UWB microcontroller 704. In some embodiments, the stability criterion is satisfied when the implant device 110 successfully completes an NFC-based handshake with the wearable device 130, maintains adequate coupling, and sustains a commanded test load without loss of communication or loss of power.

In some embodiments, the higher-level communication circuitry comprises (918) a Bluetooth Low Energy (BLE) microcontroller (e.g., BLE microcontroller 707, BLE microcontroller 714) and an ultra-wideband (UWB) microcontroller (e.g., UWB microcontroller 704, UWB microcontroller 712).

In some embodiments, the method further includes selectively powering (920) one or more components of the cranial implant device over the NFC channel before enabling the higher-level communication circuitry.

In some embodiments, the method includes receiving (922) a firmware update via the NFC channel while a Bluetooth Low Energy (BLE) communication channel is unavailable.

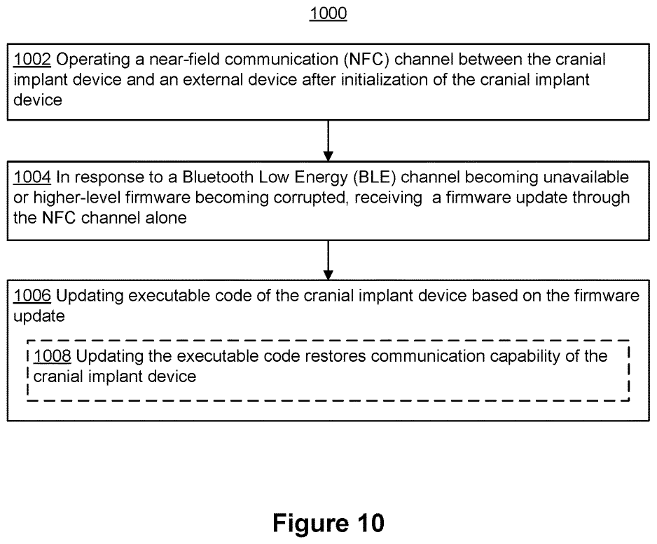

FIG. 10 is a flowchart of an example process for recovering operation of a cranial implant device, in accordance with some embodiments. The method 1000 is performed at a cranial implant device (e.g., implant device 110). In some embodiments, the cranial implant device includes a UWB radio module (e.g., UWB radio module 706). In some embodiments, the cranial implant device includes a Bluetooth Low Energy (BLE) radio module (e.g., BLE microcontroller 707). In some embodiments, the cranial implant device includes an NFC module (e.g., NFC tag 708). In some embodiments, the operations shown in FIGS. 1A-1D, 2A to 2D, 3A, 3B, 6A-6E, and 7 correspond to instructions stored in the memory block of an ASIC of the cranial implant device. Some operations in the method 1000 can be combined with other operations described in method 800 and/or method 900, and/or the order of some operations may be changed.

The method includes operating (1002) a near-field communication (NFC) channel between the cranial implant device and an external device after initialization (e.g., boot up) of the cranial implant device.

The method includes, in response to a Bluetooth Low Energy (BLE) channel becoming unavailable or higher-level firmware becoming corrupted, receiving (1004) a firmware update through the NFC channel alone.

The method includes updating (1006) executable code of the cranial implant device based on the firmware update.

In some embodiments, updating the executable code restores (1008) communication capability of the cranial implant device.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Turning now to some example embodiments:

(A1) In accordance with some embodiments, a cranial implant device comprises (1) a hermetically sealed enclosure including a lid having a first biocompatible material and a main body having a second biocompatible material different from the first biocompatible material; and (2) a set of components enclosed in the hermetically sealed enclosure, the set of components including: (2a) a power delivery coil positioned on a first substrate, distinct from the lid, the power delivery coil configured to deliver electrical power from an external device to the cranial implant device; and (2b) one or more antennas positioned on a second substrate, distinct from the lid, the one or more antennas configured to enable communication with the external device.

(A2) In some embodiments of A1, the first substrate is a first printed circuit board (PCB); and the second substrate is a second printed circuit board (PCB) that is different from the first PCB.

(A3) In some embodiments of A2, the first PCB and the second PCB comprise flexible PCBs.

(A4) In some embodiments of A2-A3, the first PCB comprises a polyimide PCB and the second PCB comprises a liquid crystal polymer (LCP) PCB.

(A5) In some embodiments of any of A1-A4, the set of components are arranged as a plurality of layers within the hermetically sealed enclosure; and the power delivery coil and the one or more antennas are configured to be arranged in a first layer, of the plurality of layers, adjacent to the lid.

(A6) In some embodiments of A5, the first substrate is configured to surround the second substrate in the first layer.

(A7) In some embodiments of any of A1-A6, the one or more antennas comprise a plurality of antennas, the plurality of antennas including: an ultra-wideband (UWB) antenna; and a Bluetooth Low Energy (BLE) antenna. In some embodiments, the ultra-wideband (UWB) antenna is configured to operate in a capacitive mode. In some embodiments, the BLE antenna is configured to operate in a capacitive mode.

(A8) In some embodiments of A7, the cranial implant device is configured to be anchored to a skull of a patient; and the UWB antenna is configured to transmit neural data of the patient to an external device. In some embodiments, the neural data comprises raw, unprocessed neural data. In some embodiments, the cranial implant device includes a UWB radio module coupled to the UWB antenna; the UWB radio module configured to transmit the raw, unprocessed neural data unidirectionally to the external device. In some embodiments, the cranial implant device includes a Bluetooth Low Energy (BLE) radio module coupled to the BLE antenna, the Bluetooth Low Energy (BLE) radio module configured to receive interaction data from the external device and transmit feedback data to the external device.

(A9) In some embodiments of A8, the hermetically sealed enclosure is coupled to bonding pads of a sensing array that is positioned on a surface of a brain of the patient; and the hermetically sealed enclosure is configured to receive the neural data of the patient via the bonding pads.

(A10) In some embodiments of any of A8-A9, the neural data consists of unprocessed data. In some embodiments,, the neural data consists of raw, unprocessed neural data

(A11) In some embodiments of any of A1-A10, the one or more antennas include a near-field communication (NFC) antenna. In some embodiments, the NFC antenna is positioned on the first substrate with the power delivery coil. In some embodiments, the NFC antenna and the power delivery coil are separate conductive structures. In some embodiments, the NFC antenna and the power delivery coil are implemented as a common conductive structure.

(A12) In some embodiments of any of A1-A11, the set of components includes: a spacer component positioned immediately adjacent to the power delivery coil and the one or more antennas, away from the lid; and a ferrite component positioned immediately adjacent to the spacer component. In some embodiments, the lid has an effective permittivity greater than an effective permittivity of the spacer component such that signal propagation is directed toward the lid. In some embodiments, the ferrite component is configured to suppress downward radiation and reduce reflection of residual radiation back toward the one or more antennas. In some embodiments, the spacer component is configured to mechanically stabilize the ferrite component. In some embodiments, the spacer component is configured to mechanically stabilize the ferrite component under magnetic-field exposure.

(A13) In some embodiments of A12, the spacer component comprises a foam material.

(A14) In some embodiments of any of A12-A13, a dielectric permittivity value of the spacer component is close to one.

(A15) In some embodiments of any of A12-A14, the set of components further includes: a shielding component positioned immediately adjacent to the ferrite component; and a main electronics board positioned immediately adjacent to the shielding component.

(A16) In some embodiments of A15, the first substrate is coupled to the main electronics board via a first flex connector.

(A17) In some embodiments of A16, the second substrate is coupled to the main electronics board via a second flex connector, distinct from the first flex connector.

(A18) In some embodiments of any of A1-A17, the hermetically sealed enclosure is formed by joining the lid to the main body via one or more of: welding, and brazing.

(A19) In some embodiments of any of A1-A18, the hermetically sealed enclosure is formed by joining the lid to the main body via a high temperature joining process.

(A20) In some embodiments of any of A1-A19, the first biocompatible material comprises a ceramic material and the second biocompatible material comprises a titanium material.

(A21) In some embodiments of A20, the ceramic material is a zirconia-based ceramic material.

(A22) In some embodiments of any of A1-A21, the cranial implant device is a battery-less device.

(B1) In accordance with some embodiments, a cranial implant device comprises (1) a hermetically sealed enclosure including a lid having a first biocompatible material and a main body having a second biocompatible material different from the first biocompatible material; and (2) a set of components enclosed in the hermetically sealed enclosure, the set of components including: (2a) an ultra-wideband (UWB) antenna configured to enable communication with an external device, wherein the UWB antenna is positioned on a printed circuit board (PCB) and is configured to be located immediately adjacent to the lid without physically contacting the lid.

(B2) In some embodiments of B1, the set of components includes a spacer component positioned adjacent to the UWB antenna, away from the lid. In some embodiments, the lid has an effective permittivity greater than an effective permittivity of the spacer component such that signal propagation is directed toward the lid.

(B3) In some embodiments of B2, the set of components includes a ferrite component positioned immediately adjacent to the spacer component; and the spacer component is between the UWB antenna and the ferrite component.

(C1) In accordance with some embodiments, a cranial implant device comprises (1) an ultra-wideband (UWB) antenna; (2) a Bluetooth Low Energy (BLE) antenna; (3) a UWB radio module coupled to the UWB antenna, the UWB radio module configured to transmit short-range, wireless neural data unidirectionally to an external device; and (4) a BLE radio module coupled to the BLE antenna, the BLE radio module configured to receive and transmit short-range, wireless side band data.

(C2) In some embodiments of C1, the cranial implant device is a battery-less device.

(C3) In some embodiments of any of C1-C2, the cranial implant device further comprises a near-field communication (NFC) tag, configured to: (i) establish initial communication with the external device; and (ii) connect the BLE radio module to the external device.

(C4) In some embodiments of C3, the NFC tag is configured to receive wireless power signals from the external device to operate the cranial implant device.

(C5) In some embodiments of any of C1-C4, the cranial implant device is magnetically coupled to the external device.

(C6) In some embodiments of any of C1-C5, the neural data consists of unprocessed neural data.

(D1) In accordance with some embodiments, a brain computer interface (BCI) system comprises the cranial implant device of any of C1-C6 and the external device of any of C1-C6.

(E1) In accordance with some embodiments, a cranial implant device comprises (i) an ultra-wideband (UWB) antenna; (ii) a near-field communication (NFC) antenna; (iii) a UWB radio module coupled to the UWB antenna, the UWB radio module configured to transmit short-range, wireless neural data unidirectionally to an external device; and (iv) an NFC module coupled to the NFC antenna, the NFC module configured to receive wireless power signals from the external device.

(E2) In some embodiments of E1, the NFC module is configured to establish a secure handshake with the external device.

(E3) In some embodiments of E2, the secure handshake with the external device comprises a secure BLE handshake; and the cranial implant device further includes a BLE antenna and a BLE radio module coupled to the BLE antenna.

(E3) In some embodiments of any of E1-E2, the cranial implant device is a battery-less device.

(F1) In accordance with some embodiments, a method for communicating neural data is performed at a brain computer interface (BCI) system that includes a cranial implant device and an external device. The cranial implant device includes a UWB radio module and a Bluetooth Low Energy (BLE) radio module. The method comprises (1) transmitting, via the UWB radio module, short-range, wireless neural data unidirectionally to the external device; (2) receiving, via the BLE radio module, short-range wireless interaction data from the external device; and (3) transmitting, via the BLE radio module, feedback data (e.g., side band data) to the external device.

(F2) In some embodiments, of F1, the cranial implant device includes an NFC module; and the method includes receiving, via the NFC module, wireless power signals from the external device.

(F3) In some embodiments of any of F1-F2, the cranial implant device includes an NFC module; and the method includes establishing, via the NFC module, initial communication with the external device.

(F4) In some embodiments of F3, the method further comprises, after establishing, via the NFC module, the initial communication with the external device: connecting, via the NFC module, the BLE radio module to the external device.

(G1) In accordance with some embodiments, a method for booting (e.g., initializing) a cranial implant device comprises: (i) receiving, via a near-field communication (NFC) module of the cranial implant device, an NFC signal from an external device; (ii) powering at least a portion of the cranial implant device using the NFC signal; (iii) establishing initial communication with the external device over an NFC channel; (iv) communicating with the external device over the NFC channel; (v) verifying, based on the communicating, that a wireless power-delivery link between the external device and the cranial implant device satisfies a stability criterion; and (vi) in response to verifying that the wireless power-delivery link satisfies the stability criterion, enabling higher-level communication circuitry of the cranial implant device.

(G2) In some embodiments of G1, verifying that the wireless power-delivery link satisfies the stability criterion comprises enabling an artificial load in the cranial implant device, to stress-test the wireless power-delivery link between the external device and the cranial implant device.

(G3) In some embodiments of G1 or G2, the higher-level communication circuitry comprises a Bluetooth Low Energy (BLE) microcontroller and an ultra-wideband (UWB) microcontroller.

(G4) In some embodiments of any of G1-G3, the method further comprises receiving a firmware update via the NFC channel while a Bluetooth Low Energy (BLE) communication channel is unavailable.

(G5) In some embodiments of any of G1-G4, communicating with the external device over the NFC channel includes performing a handshake with the external device.

(G6) In some embodiments of any of G1-G5, the method further includes selectively powering one or more components of the cranial implant device over the NFC channel before enabling the higher-level communication circuitry.

(H1) In accordance with some embodiments, a method for recovering operation of a cranial implant device comprises: (1) operating a near-field communication (NFC) channel between the cranial implant device and an external device after initialization of the cranial implant device; (2) in response to a Bluetooth Low Energy (BLE) channel becoming unavailable or higher-level firmware becoming corrupted, receiving a firmware update through the NFC channel alone; and (3) updating executable code of the cranial implant device based on the firmware update.

(H2) In some embodiments of H1, updating the executable code restores communication capability of the cranial implant device.

(I1) In accordance with some embodiments, a brain computer interface (BCI) system includes a cranial implant device and an external device. The cranial implant and the external device include processing circuitry configured to perform the method of any of F1-F4, G1-G6, and H1-H2.

(J1) In accordance with some embodiments, a brain computer interface (BCI) system comprises (1) a cranial implant device that includes a UWB radio module and a Bluetooth Low Energy (BLE) radio module; (2) an external device; and (3) processing circuitry configured to: (3a) transmit, via the UWB radio module, short-range, wireless neural data unidirectionally to the external device; (3b) receive, via the BLE radio module, short-range wireless interaction data from the external device; and (3c) transmit, via the BLE radio module, feedback data to the external device.

(K1) In accordance with some embodiments, a brain computer interface (BCI) system comprises (i) a cranial implant device including a UWB radio module, a Bluetooth Low Energy (BLE) radio module, and a near-field communication (NFC) module; and (ii) a wearable device including a complementary UWB radio module, BLE communication circuitry, and an NFC reader. The cranial implant device is configured to transmit neural data to the wearable device via the UWB radio module, receive wireless power from the wearable device via the NFC module, and exchange control data with the wearable device via the BLE radio module.

(K2) In some embodiments of K1, the cranial implant device is configured to transmit the neural data unidirectionally to the wearable device via the UWB radio module and to receive acknowledgement data from the wearable device via the BLE radio module.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A cranial implant device, comprising:
a hermetically sealed enclosure including a lid having a first biocompatible material and a main body having a second biocompatible material different from the first biocompatible material; and
a set of components enclosed in the hermetically sealed enclosure, the set of components including:
a power delivery coil positioned on a first substrate, distinct from the lid, the power delivery coil configured to deliver electrical power from an external device to the cranial implant device; and
one or more antennas positioned on a second substrate, distinct from the lid, the one or more antennas configured to enable communication with the external device.

2. The cranial implant device of claim 1, wherein:
the first substrate is a first printed circuit board (PCB); and
the second substrate is a second printed circuit board (PCB) that is different from the first PCB.

3. The cranial implant device of claim 2, wherein the first PCB and the second PCB comprise flexible PCBs.

4. The cranial implant device of claim 2, wherein the first PCB comprises a polyimide PCB and the second PCB comprises a liquid crystal polymer (LCP) PCB.

5. The cranial implant device of claim 1, wherein the set of components are arranged as a plurality of layers within the hermetically sealed enclosure; and
the power delivery coil and the one or more antennas are configured to be arranged in a first layer, of the plurality of layers, adjacent to the lid.

6. The cranial implant device of claim 5, wherein the first substrate is configured to surround the second substrate in the first layer.

7. The cranial implant device of claim 1, wherein the one or more antennas comprise a plurality of antennas, the plurality of antennas including:
an ultra-wideband (UWB) antenna; and
a Bluetooth Low Energy (BLE) antenna.

8. The cranial implant device of claim 7, wherein:
the cranial implant device is configured to be anchored to a skull of a patient; and
the UWB antenna is configured to transmit neural data of the patient to an external device.

9. The cranial implant device of claim 1, wherein the one or more antennas include a near-field communication (NFC) antenna.

10. The cranial implant device of claim 1, wherein the set of components includes:
a spacer component positioned immediately adjacent to the power delivery coil and the one or more antennas, away from the lid; and
a ferrite component positioned immediately adjacent to the spacer component.

11. The cranial implant device of claim 10, wherein the spacer component comprises a foam material.

12. The cranial implant device of claim 10, wherein a dielectric permittivity value of the spacer component is close to one.

13. The cranial implant device of claim 10, wherein the set of components further includes:
a shielding component positioned immediately adjacent to the ferrite component; and
a main electronics board positioned immediately adjacent to the shielding component.

14. The cranial implant device of claim 13, wherein the first substrate is coupled to the main electronics board via a first flex connector.

15. The cranial implant device of claim 14, wherein the second substrate is coupled to the main electronics board via a second flex connector, distinct from the first flex connector.

16. The cranial implant device of claim 1, wherein the first biocompatible material comprises a ceramic material and the second biocompatible material comprises a titanium material.

17. The cranial implant device of claim 16, wherein the ceramic material is a zirconia-based ceramic material.

18. A cranial implant device, comprising:
a hermetically sealed enclosure including a lid having a first biocompatible material and a main body having a second biocompatible material different from the first biocompatible material; and
a set of components enclosed in the hermetically sealed enclosure, the set of components including:
an ultra-wideband (UWB) antenna configured to enable communication with an external device, wherein the UWB antenna is positioned on a printed circuit board (PCB) and is configured to be located immediately adjacent to the lid without physically contacting the lid.

19. The cranial implant device of claim 18, wherein the set of components includes a spacer component positioned adjacent to the UWB antenna, away from the lid.

20. The cranial implant device of claim 19, wherein:
the set of components includes a ferrite component positioned immediately adjacent to the spacer component; and
the spacer component is between the UWB antenna and the ferrite component.
